(19) United States
(12) Patent Application Publication
(10) Pub. No.: US 2006/0118707 A1
(43) Pub. Date: Jun. 8, 2006

(54) Optical controls

(76) Inventor: Henk Schaake, Drachten (NL)

Correspondence Address: VIERRA MAGEN MARCUS & DENIRO LLP, 575 MARKET STREET SUITE 2500, SAN FRANCISCO, CA, 94105, US

(21) Appl. No.: 10/510,376

(22) PCT Filed: Apr. 8, 2003
(86) PCT No.: PCT/GB03/01524

§ 371 Date: Aug. 1, 2005

(30) Foreign Application Priority Data
Apr. 8, 2002 (GB) 0208048.9

(51) Int. Cl. G01D 5/34

(52) U.S. Cl. 250/231.13

(57) ABSTRACT

An optical control in the form of a rotary optical encoder includes a Gray code generating disk (9), a light source (3), a series of three light detectors (4), and an apertured cover (5) arranged over the light detectors (4). The control further includes a reflector (12) which redirects the light from the light source (3) to the detectors (4). The reflector (12) comprises a first parabolic reflective surface (14) which reflects the incident light from the light source (3) into a number of parabolic secondary reflective surfaces (15), each of which reflects and concentrates the light through the apertured cover (5) towards a particular light detector (4).

The present invention relates to optical controls, such as optical switches and optical encoders. More particularly, the invention relates to optical controls, such as toggle switches and selector switches, which provide an output indicative of the state of the switch. The invention also relates to optical controls, such as turn knob controls, slider controls and so forth, which comprise optical encoders that provide an output indicative of the position of a control member. The invention extends to optical encoders per se that can provide an output which indicates the position, or movement, of a mechanical element.

Many conventional mechanical controls convert a mechanical input, such as the flicking of a switch or the positioning of a turn knob or slider, into an electrical output. For example, a conventional turn knob control may comprise a rotary potentiometer in which the position of a movable electrical contact generates an analogue signal indicative of the position of the turn knob. Similarly, a conventional slider control may comprise a linear potentiometer.

There has however been a trend away from the use of such conventional controls, and towards the use of non-contact optical controls. This has occurred for a number of reasons.

One factor in the increased use of optical controls is that conventional controls, such as potentiometers, rely on the mechanical movement of one part against another which can lead to mechanical wear. Such controls may therefore have a shorter operating life when compared to an equivalent, non-contact optical control. A further problem associated with many conventional controls is corrosion of metal parts, such as electrical contacts, which can again reduce the useable lifespan of this type of control. Mechanical switches can also be susceptible to switch contact bounce which can require a time delay to be built into the switch operation to avoid, e.g., multiple switching due to such “bouncing”.

Optical controls may also be preferred due to the increasing desire to use digital rather than analogue technology in electronic equipment. Unlike some conventional mechanical/electrical controls, such as rotary and linear potentiometers, which provide an analogue output and so require additional electronics to convert the analogue output from the control into a digital signal, optical controls can more easily directly provide a digital output that can be directly interfaced with, e.g., a microprocessor, and so can avoid the additional expense of providing electronics to convert an analogue signal.

Optical controls and encoders operate, as is known in the art, by means of a movable control member affecting the amount (e.g. intensity) of electromagnetic radiation falling on a suitable detector. By determining the amount of radiation falling on the detector, the position of the control member of the optical control or encoder can be determined. Such optical controls and encoders typically use infra-red radiation or visible light, although any suitable form of electromagnetic radiation can be used.

One example of a relatively simple optical control is an on/off switch which comprises a light (radiation) source, a light (radiation) detector and means, such as a toggle lever, that can be moved to selectively block light (radiation) from passing from the light source to the light detector. The light source may comprise, say, a light emitting diode and the light detector may comprise a phototransistor. The electrical output of the phototransistor (which will depend on whether it is receiving light or not) indicates the state of the switch.

Optical equivalents of conventional rotary turn knob controls and linear slider controls are also known. In these types of optical controls, unlike in simple switches, a control member has a range of movement, and the position of the control member within this range is determined by optical means.

A simple form of a rotary optical encoder comprises a rotatable shaft, one end of which is attached to a control member that can be turned by a user. The other end of the shaft is located within a housing and is attached to, and moves with, a radially extending disk. The disk is formed from a photographic material and is divided into a number of concentric tracks. Each track comprises a pattern of transparent and opaque regions which, respectively, allow or prevent light from passing through the disk. A number of light sources are positioned on one side of the disk, one light source in line with each track on the disk. On the other side of the disk, a number of light detectors are positioned, again one light detector in line with each track on the disk. In this way, light from a light source can be directed through each track at a corresponding light detector. Each light detector indicates whether or not it is exposed to light, i.e. whether it is covered by a transparent or opaque region of its respective track. Thus if four tracks and four light detectors are provided, the pattern of transparent and opaque regions on the tracks can be arranged to generate 16 unique digital codes (typically in a Gray code form) which correspond to 16 angular sub-ranges of the total range of angular movement of the control member. Typically, in practice, a greater number of tracks would be provided to achieve a greater angular resolution, say 8 tracks providing 256 codes representing 256 distinct angular sub-ranges of the total movement of the control member. A device of this type will generate a digital code characteristic of, and dependent on, the position of the control member.

A typical linear optical encoder employs the same principle as the above rotary optical encoder but instead of providing a code generating disk, a linearly movable plate is provided connected to a linear slider. The plate includes a number of linear patterned tracks and is disposed between a number of light sources on one side and a number of light detectors on the other side.

As well as optical encoders that produce a digital output, optical controls that generate an analogue output corresponding the state of the control are also know. In such an analogue optical control, rather than the or each detector simply having “on” and “off” states, the control member is arranged so as to vary in a continuous fashion the intensity of the light received by the detector in a way that is dependent on the position of the control member. This could be achieved, for example, by the control member moving an opaque pattern that has a varying width over the detector such that the proportion of the detector's input aperture that is exposed to the light from the light source varies depending on the position of the control member. Another way of selectively attenuating the light intensity received by the light detector is for the control member to move a pattern of varying opacity over the detector.

Such analogue optical controllers have the advantage that only a single light source and light detector pair is needed to encode a range of control or switching states. However, such analogue controls can be less accurate and precise than “digital” equivalents, as the light intensity determination can be susceptible to errors introduced by, for example, manufacturing tolerances in the width or opacity of the code pattern, and in the positioning of the light source, code pattern and light detector relative to each other, as well as ageing and temperature effects on the detector sensitivity and light source intensity.

Whilst known optical controls and encoders of the type described above have a number of advantages, particularly over more conventional mechanical controls, they also suffer from a number of drawbacks.

For example, a typical conventional optical control has the light sources and corresponding light detectors arranged in a face-to-face relationship, and typically comprises a first subassembly comprising one or more light sources, typically LEDs, mounted on a printed circuit board, and a second subassembly comprising one or more light detectors, typically phototransistors, mounted on a second printed circuit board. The printed circuit boards provide support to and electrically connect the various electronic components. The two subassemblies are then mounted within a housing facing each other, which housing also includes electrical connectors to enable the control to be mounted and connected to other components, such as a main printed circuit board. The construction of such controls, and the mounting of these devices on a main printed circuit board as is often required, can be relatively labour intensive and time consuming.

The present invention therefore aims to improve on known optical controls, such as optical encoders, and in particular, aims to provide improved forms of construction of such components.

From a first aspect, the present invention provides an optical control comprising:

one or more light sources; and

one or more reflectors arranged to reflect light from the light source or sources to redirect that light and concentrate that light towards one or more locations.

In the optical control of this aspect of the present invention a reflector is used to redirect light from the light source. Using a reflector in this manner enables increased flexibility in the positioning and orientation of the optical components within the optical control, as it, for example, removes the restriction in conventional optical controls of having to arrange light sources and light detectors in a face-to-face relationship.

The reflector or reflectors also act to concentrate the light from the light source to one or more locations. Concentrating the light from the light source to one or more particular locations facilitates more efficient use of the light available from a given light source, as compared, for example, to arrangements in which the light from the light source is simply allowed to follow its natural (usually dispersive) path. This for example, facilitates using fewer light sources for a given number of detectors without compromising the light intensity received by each individual detector and/or reduces the power required to couple sufficiently effectively the light source or sources to the detectors. Concentrating the light from the light source in this manner can also help to ensure reliable separation and resolution between individual detectors and to reduce the risk of “crosstalk” and interference between individual detectors in use. Using a reflector or reflectors both to redirect and concentrate the light from the light source or sources is a particularly convenient and effective technique for achieving these functions.

A simple form of the invention may, for example, comprise an optical control provided with a single light source and a single light detector, wherein light from the light source is concentrated by a reflector onto the light detector. The invention however is not limited in the number of light sources, light detectors and reflectors that may be provided in an optical control, provided that some form of reflector is used to direct and concentrate light.

The type of light source used in the present invention may comprise any suitable light emitting device. As discussed above, although typically infra-red radiation and/or visible light will be used in the present invention, it is applicable to any other suitable form of electromagnetic radiation and thus “light” source (and “light” detector) as used herein should be construed accordingly. Preferably, the light source comprises an electronic component, such as a light emitting diode (LED), which produces light from an electrical input. Most preferably, the light source comprises an infra-red LED.

The light from the light source or sources should be redirected via the reflector or reflectors to a light detector or detectors for appropriate detection (with the presence or otherwise of light at the detector(s) being indicative of the state of the optical control, as is known in the art). The light detector or detectors themselves may take any form that is suitable for detecting the electromagnetic radiation emitted by the (light) source or sources. Preferably, they comprise an electronic component, such as a phototransistor, which produces an electric current when exposed to light (or other electromagnetic radiation).

The light detectors could be mounted, as is conventional, in close proximity to the light sources, i.e. be part of the optical control itself, with those light detectors then providing an electronic signal which can be transmitted elsewhere for processing, etc. Thus in one preferred embodiment, the optical control further includes one or more light detectors.

However, it is not necessary with the arrangement of the present invention to mount the light detectors for the optical control in relatively close proximity to the light sources. Indeed, the Applicants have recognised that there may be some circumstances where it may be advantageous not to have to mount the light detectors close to the light sources of a given optical control. For example, where there are plural optical controls on, e.g., a single circuit board, it may be advantageous to be able to use the same light detectors for each control (e.g. in terms of component numbers and ease of construction). The present invention facilitates such a construction since it, for example, allows the optical output of a control to be directed as desired by the reflector (e.g. via an optical fibre to an “off-control” light detector).

Thus in another preferred embodiment of the invention, the arrangement and preferably the optical control includes light transmitting means that can transmit the optical output of the control to a light detector or detectors that is or are spaced apart from the optical control (e.g. mounted elsewhere on the printed circuit board). In this arrangement, preferably one set of light detectors, e.g. provided integrally with a main microprocessor of the system, receives the light output from plural optical controls. In this way an optical rather than electrical connection may be provided between the optical controls and other components, such as a microcontroller of the system.

Thus in a particularly preferred embodiment, there is a common detector or set of detectors that is shared by plural optical controls. In such an arrangement, the equivalent or corresponding outputs (e.g. bit positions (binary weights) for digital controls and encoders) of each optical control are preferably transmitted to the same detector, as that facilitates processing of the outputs of each of the controls.

These arrangements are believed to be advantageous in their own right and thus from a further aspect, the present invention provides an optical control, wherein the control provides an optical output indicative of the state or position of the control, and wherein the optical output can be transmitted by light transmitting means to another remote component for subsequent processing.

From a yet further aspect, the present invention provides an optical system comprising a plurality of optical controls, wherein the optical controls each provide an optical output indicative of the state of the control; the system further comprising light transmitting means to transmit the optical outputs of the controls to a processing unit capable of reading the optical data generated by the controls.

In these arrangements, the light transmitting means may take any suitable form, such as an arrangement of optical fibres. The light transmitting means can preferably be relatively easily fixed in position, say to the underside of a printed circuit board. In this way, a number of light transmitting means can be provided to effectively form a data bus which conducts light as opposed to electrical current which would be carried by a conventional electronic data bus.

The light transmitting means should provide the optical information in the output from the optical control to remote light detectors where the optical output is converted into electrical data so that it can be processed, say by a microcontroller. Preferably therefore an arrangement of light detectors, such as phototransistors, is provided to receive the optical information from the light transmitting means. The means of converting the optical data into electronic data may take any suitable form and may, for example, be provided integrally with a main processing unit or alternatively as a separate unit.

Where the optical output of one or more controls are transmitted via light transmitting means to a (common) set of remote detectors then the light transmitting means could, e.g., themselves provide the medium via which the light is transmitted from each control to the detectors. In such an arrangement, for example, one or more light transmitting means such as an optical fibre or fibres would extend from the or each optical control to the remote detector or detectors. However, the Applicants have recognised that such arrangements can be relatively costly and complex, particularly, for example, when many optical fibres are to be routed between a number of optical controls and detectors.

Thus, in a particularly preferred embodiment, the light transmitting means act to redirect the light from the optical control or controls towards the (remote) light detector or detectors, but the light transmitting means (e.g. optical fibre) does not itself extend significantly between the optical control and the light detector(s) (such that the light (electromagnetic radiation) effectively propagates through the air (i.e. in free space) between the optical control and the detector(s). This arrangement has the advantage of, for example, avoiding the complexity and expense of having to provide optical fibres extending all or substantially all of the distance between each optical control and the light detectors. In these embodiments the radiation preferably travels at least 50%, more preferably at least 70%, and most preferably at least 90% of the distance between the control and the detector in free air.

In such an embodiment, the light transmitting means could, e.g., comprise any suitable means that can redirect the light appropriately, such as one or more reflectors, e.g. in the form of mirrors. However, in a particularly preferred embodiment, the light transmitting means comprise relatively short lengths of light transmissive material that can accept light from the optical control at one end and emit it at the other end and are shaped so as to redirect the light towards the detector or detectors. Such components could comprise, e.g., short lengths of optical fibre or other suitably radiation transmissive material (e.g. clear plastic) that are shaped (e.g. bent along their length) so as to redirect the light that is incident on their input end. In effect, they will act as short lengths of “light pipe”, that will accept light at one end and are bent so as to emit the light in a different direction (in practice selected so as to direct the light to the appropriate detector location). In general, the “light pipes” will need to have a relatively small diameter as compared to their length in order for them to be able to capture light at one end and conduct it to their other end to redirect it, but can otherwise have any suitable configuration.

It will be appreciated that in these embodiments and arrangements the direction that the light from each optical control is redirected towards (and hence, e.g., the shape and extent of bending of a given “light pipe”) will vary depending on, e.g., the overall optical control(s), detector(s) and printed circuit board layout and the location of the individual optical control and its output in question. This essentially means that the each redirection “direction” (and thus, e.g., “light pipe”) will not be identical but will differ due, e.g., to the differing locations of each control relative to the detector(s). However, it should in practice be relatively straightforward to ensure that the light from each control is appropriately redirected to fall within the acceptance field of the relevant detector.

That said it is preferred when using such an arrangement for the light detectors to be mounted beneath the substrate (e.g. printed circuit board) on which the optical controls are mounted, and for the light transmitting (redirecting) means (e.g. short lengths of light transmissive material) to conduct the optical output of the controls under the substrate and then direct it towards the detectors. It is preferred in such an arrangement that the change in direction of the light path effected by the light transmitting means is less than 90°, as that achieves a relatively compact structure vertically, but helps to avoid the output of a given light transmitting means being blocked by neighbouring light transmitting means. Preferably the light path is bent by around 75° from its initial direction.

It will be appreciated that in these arrangements, in the case where an optical control has plural individual outputs, then there will preferably be more than one remote detector, and most preferably a different detector for each of the different outputs of the or an individual optical control. While it would be possible in these circumstances to arrange all the detectors that the outputs a given optical control (and preferably all of the optical controls) will be directed towards in the same general location (e.g. side-by-side), it is preferred, particularly where the optical output of the control or controls travels through free air to the plural detectors, for the different detectors to be located in spaced apart locations, as that helps to allow the relevant outputs of the optical controls to be distinguished by the different detectors. Most preferably, the detectors are mounted so as to be outside of and surrounding the optical controls that they service. They are also preferably located so as to be angularly spaced as far apart as possible.

Thus, for example, in such an arrangement the detectors could be located in different corners in the plane in which they and/or the optical controls are mounted (e.g. of the substrate (e.g. printed circuit board) on which they and/or the optical controls are mounted) or at substantially equal angular spacings around the circumference of the (common substrate) on which they are mounted and/or of a circle generally surrounding the optical controls.

Thus, in a particularly preferred embodiment, where a given optical control or encoder has plural outputs, the optical control or encoder will include a number of light transmitting means corresponding to its number of outputs that redirect the light from each output to propagate in free air towards spaced apart detectors, i.e. in distinctly different directions.

As discussed above, when common detectors for plural controls or encoders are used, the equivalent or corresponding outputs of each individual control are preferably directed to the same detector. Thus, in a particularly preferred arrangement of this embodiment of the invention, the equivalent outputs of each control or encoder mounted on the substrate will be directed to a given detector, e.g., corner of the substrate. Thus, for example, the corresponding binary weight outputs (bit position outputs) of each control or encoder will be directed to the same, distinctly located detector, with the other binary weight outputs of the controls and encoders being directed to different, distinctly located detectors, i.e. in a different direction.

It will be appreciated that these arrangements in which the optical output propagates in air to a remote detector or detectors are particularly applicable to “digital” encoding methods, as then only the “on” or “off” state of the output needs to be determined. However, such arrangements could also be used for analogue encoding, although in that case account may need to be taken of the potentially differing free air propagation distances between a given output and the detector.

It is believed that such arrangements may be advantageous in their own right. Thus, according to another aspect of the present invention, there is provided an optical control system, comprising: a plurality of optical controls mounted on a substrate, each optical control comprising one or more light redirecting means for directing its optical output to travel through free space to a remote detector or detectors that is or are common to the plurality of optical controls.

It will be appreciated that this aspect of the invention can include any one or more or all of the preferred features discussed above. Thus, for example, the light redirecting means preferably comprise short lengths of transmissive material that can accept the light output from the optical control at one end and are bend so as to emit that light output at their other end in the direction of the appropriate detector. Similarly, it is preferred that the corresponding or equivalent outputs (e.g. in terms of their bit position (binary weighting)) of each control are directed to the same detector (from among the set of common detectors)

It can be seen from all of the above that in one preferred arrangement of the present invention, the optical system comprises a number of optical controls that do not themselves include light detecting means, but instead transmit their optical data via, say optical fibres or free space, to a set of light detectors which finally convert the optical data into electronic data. In this way, particularly on larger control panels which have many optical controls, significant cost savings can be made since the number of light detectors required can be reduced.

The reflector or reflectors may take any suitable form for redirecting the light from the light sources. A reflector may comprise a separately formed element or alternatively may be integrally formed with a housing for the control. Preferably, the reflector comprises a moulded element, say formed from plastic, that is provided with a reflective, mirrored coating. A single or more than one reflector may be provided.

The reflector or reflectors (or at least one of the reflectors if there is more than one) should concentrate the light from the light source or sources towards one or more locations. This can be achieved in any suitable manner that will concentrate the light towards a given location or locations (e.g. point or points), such as by converging the light towards the location or locations. Preferably the reflector or reflectors act to focus the light towards or at the location or locations. The reflector or reflectors should be shaped so as to achieve the concentrating effect. They can have any suitable shape to achieve the concentrating effect, such as being generally concave. The light-concentrating reflector or reflectors preferably has a substantially parabolic shape, as that will have a strong focussing effect on the light. Preferably the (light-concentrating) reflector or reflectors are parabolic so far as is possible within, for example, manufacturing tolerances.

The location or locations that the light is concentrated towards can be selected as desired. However, it will be appreciated that in practice the greatest benefit will be achieved if the light is concentrated or focussed towards or on to the corresponding light detector (or intermediate light transmitting or light redirecting means where the detectors are remote from the control). It should be appreciated in this regard that the detector or light transmitting or redirecting means need not be located exactly at the point of concentration or focus of the reflector (although that is preferred), but could be located at another point in the path of the concentrated (focussed) light beam, as there will still even in that case be some concentration of the light towards the detector, etc.

In a particularly preferred embodiment, the reflector or reflectors are arranged to reflect light from a single light source to plural light detectors (via light transmitting or redirecting means, if desired). For example, the light from one light source could be appropriately redirected by a reflector to two (or more) different light detectors. This would allow a number of light detectors to be operated using light from one light source. This arrangement allows optical controls to be constructed using fewer components, thus providing more simplified construction and cost savings. Directing the light from a single light source to plural light detectors and concentrating the light output from the light source as in aspects and preferred embodiments of the present invention is particularly advantageous, as concentrating the light output helps to compensate for the fact that the light from a single source is to be spread between several detectors. Thus in a particularly preferred embodiment the or a reflector or reflectors of the or each optical control acts to concentrate the light from a or the light source to more than one location.

It is believed that such arrangements may be advantageous in their own right. Thus, from a further aspect, the present invention provides an optical control comprising:

one or more light sources;

means for splitting the light from a single light source into plural different paths, whereby light from one light source can be directed at plural different light detectors.

From a further aspect, the present invention provides an optical control comprising:

one or more light sources;

a plurality of light detectors;

wherein light from one light source is directed at two or more of the light detectors.

In these aspects of the invention, light from the light source can be directed at (and preferably also concentrated towards) a number of light detectors by any suitable means, such as by the use of known optical components such as mirrors, prisms, optical fibres and so on. It is preferably, as discussed above, directed at (and preferably also concentrated towards) a number of light detectors using one or more reflectors.

The way that the reflector or reflectors, etc., directs light from one light source to plural light detectors can be selected as desired. Preferably the light is effectively split into plural distinct (and spaced apart) paths, one for each detector. Thus in a preferred embodiment the or a reflector or reflectors will concentrate the light towards two or more spaced-apart locations.

In a preferred such arrangement, a reflector is provided with two main reflective surfaces, a first reflective surface which diverts incoming light from a light source toward a second reflective surface which diverts the light over a number of light detectors. The first reflective surface preferably acts to collimate the light from the light source (or sources) towards the second reflective surface. It could, e.g., have an appropriate shape, such as being concave or parabolic to do so. The second reflective surface should then divert the light towards two or more locations and could, for example, contain appropriately shaped regions to divert the light accordingly, or be made up of a number of spaced individual reflective regions that do so. In an alternative arrangement, two reflectors can be provided which respectively function as the first and second reflective surfaces of the above reflector.

In a particularly preferred embodiment, the reflector or reflectors that split the light into plural paths also concentrate or focus the light onto the light detectors (and/or into the light transmitting or redirecting means). Preferably therefore, one or more of the reflectors are profiled in order both to split the light into plural paths and to concentrate or focus each light path towards a given location (e.g. onto the light detectors). For example, in the reflector described above which possesses two main reflective surfaces, the first reflective surface which intercepts incoming light from the light source may be generally planar to reflect light onto the second surface (or may, preferably, as discussed above, generally be parabolic in order to collimate the light from the light source towards the second surface, where appropriate), and the second reflective surface can be profiled in such a way so as to split and focus the light onto each of a number of light detectors (or light transmitting or redirecting means).

As discussed above, as well as concentrating the light, a reflector or reflectors of the optical control should also act to redirect the light from the light source.

The way and direction that the reflector(s) redirect the light can be selected as desired. However, in a particularly preferred embodiment, the reflector(s) is arranged to redirect the light such that it generally returns towards the light source (but laterally spaced therefrom) after it has left the reflector(s).

Indeed the Applicants believe this arrangement to be advantageous in its own right, and thus from a further aspect, the present invention provides an optical control comprising one or more light sources and one or more light directing means arranged to redirect and concentrate the light from the light source or sources such that it is concentrated in a direction back towards the light source or sources but laterally spaced therefrom.

This arrangement enables in particular the light source(s) and light detector(s) or light transmitting means of the optical control to be placed generally side by side and facing generally in the same direction, since light from a light source can be directed by the reflector towards a position, e.g., a light detector, generally adjacent to the light source. This has the advantage that the light sources and light detectors or light transmitting (or redirecting) means can be arranged on the same surface, e.g. side-by-side, and preferably in the same plane, thereby providing, for example, simplified construction (since, e.g., two facing light source and detector assemblies are not required). Thus in a particularly preferred embodiment, the light source or sources and light detector or detectors (or light transmitting (or redirecting) means) are arranged on the same surface, preferably in the same plane, and preferably facing in the same direction.

Indeed the Applicants believe this arrangement to be advantageous in its own right, and thus from a further aspect, the present invention provides an optical control comprising one or more light sources and one or more light detectors, wherein the light sources and light detectors are arranged on the same surface.

This aspect of the invention is not necessarily limited to the use of reflectors but extends to other mechanisms or arrangements, such as the use of prisms, optical fibres or other light transmitting means, that allow optical controls to be manufactured in which the light sources and light detectors are arranged generally on the same surface.

These aspects and embodiments of the invention in particular enable optical controls to be constructed that do not require the use of a number of subassemblies comprising electronic components mounted to small printed circuit boards which must then be arranged within a housing. Instead, the electronic components of the optical control can be disposed generally side by side and (preferably) mounted to the same element conveniently therefore, the light sources and light detectors or light transmitting means can be mounted to a single printed circuit board that both supports and electrically connects these components. The number of steps required in the construction of optical controls can therefore be reduced.

The Applicants have recognised in particular that with this arrangement, it would be possible to mount the light detectors or light transmitting (or redirecting) means and light sources directly on a main printed circuit board, rather than requiring a separate optical control subassembly. Thus, in a particularly preferred embodiment, the light sources and light detectors are mounted on the same single printed circuit board, preferably a main printed circuit board of, e.g., a control panel.

Thus from a further aspect, the present invention provides a control panel comprising a control panel printed circuit board and one or more optical controls, the optical controls including light sources and light detectors, and light sources and light detectors of the controls being mounted directly on the control panel printed circuit board.

While the reflector(s) can be arranged as desired to allow the light detectors and light sources to be mounted facing in the same direction (and, e.g., side-by-side), in one preferred such form, the reflector is generally provided with two reflective surfaces. The first reflective surface is arranged at an angle to incoming light from a light source and reflects this light generally 90 degrees towards the second reflective surface. The second reflective surface is arranged at an angle to the incoming light from the first reflective surface and reflects this light generally a further 90 degrees. In this way, the light exiting the reflector can be generally directed in the opposite direction to light entering the reflector from a light source but is laterally spaced therefrom.

In the above arrangement, the two main reflective surfaces of the reflector are generally arranged at 90 degrees to each other and the reflector as a whole is oriented such that each reflective surface intersects incoming light at around 45 degrees. Alternatively, two reflectors may be provided, each respectively providing the function of the first and second reflective surfaces of the above described reflector.

As well as the light sources, light detectors or light transmitting (or redirecting) means, and reflector(s), the optical controls of the present invention can and should include other components such as are known in conventional optical controls to allow them to function. Thus they will also include an appropriate control member that a user can use to operate the control. This could be a simple push button or toggle switch, or could be a rotary or sliding control or encoder, as is known in the art. The control member should be arranged to appropriately interrupt the light path from a light source to a light detector so that its position can be determined optically. In the case of a push button or toggle switch, the switch itself could move to block the light path appropriately. Rotary or linear sliding controls should move appropriately encoded disks or plates that carry tracks having patterns of varying opacity regions or of opaque and clear regions that selectively block different light paths in the encoder depending on their position to provide, e.g., a Gray code mapping of the control member's position, as is known in the art.

In a particularly preferred embodiment, the control further includes a cover element having apertures in it arranged over the light detectors (or paths to the light transmitting (or redirecting) means, as appropriate, although this may not be necessary where lengths of light transmissive material such as optical fibres are used to convey or redirect the light output to remote detectors, as the input ends of the light transmissive material will only accept light that is appropriately incident on them in any event), so as to provide an apertured entrance for light to each individual light detector (or light transmitting means). Arranging an aperture in front of each light detector, etc., helps to reduce stray light interference and ensure that only light intended for the respective detector, etc., will reach it. This helps to enhance the sensitivity of the arrangement, and can, for example, allow more detectors, etc., to be used in a smaller area. An increased density of light detectors, etc., may be particularly beneficial in optical controls where a high density of light detectors is required, for example, in optical encoders that have code generating members of a relatively small area or that require a relatively high resolution.

Preferably a cover element which includes a corresponding number of apertures so that the cover element can be arranged over a number of light detectors, etc., with an aperture located over each light detector, etc., is used. The apertured cover element is preferably formed from moulded plastic and preferably includes a snap-fit connection to allow the cover to be snap-fitted to a printed circuit board over light detectors that are attached to the circuit board. The invention also extends to the use of a number of such covers within an optical control.

It is believed that use of an apertured cover element may be advantageous in its own right. Thus, from a further aspect, the present invention provides an optical control comprising:

one or more light sources;

a cover element formed with one or more apertures;

wherein the cover element is arranged such that light from a light source passes through an aperture in the cover element.

In this aspect and embodiments of the invention, the cover element should be arranged such that light on its path from a light source to a light detector must pass through an aperture in the cover element. Thus, where the control includes one or more light detectors, its cover element should be arranged over the light detectors with its apertures positioned such that light from a light source must pass through an aperture in the cover element to reach the light detectors.

The optical control preferably further includes a housing that can carry and cover one or more of the components of the control. The housing preferably mounts the reflector or reflectors and control member (e.g. switch) of the control, preferably in a push-fit (and preferably snap-fit) manner (as that simplifies the construction of the control). The housing could also carry the apertured cover element, if provided. The housing can preferably snap-fit to a printed circuit board, such that it can, for example, readily be mounted to a printed circuit board over the light sources and light detectors (which may be directly mounted to the printed circuit board first). The housing is preferably arranged such that it extends a uniform height above the printed circuit board, whatever the form of the optical control, as that facilitates, for example, interoperability of plural controls.

It will be appreciated by those skilled in the art that whilst it may be preferred that push-fit (preferably snap-fit) connections are provided to mount the housing, apertured covers, etc., on, e.g., a printed circuit board, any other suitable form of connection such as glueing, soldering, heat-fixing and so on may also be used.

It will be appreciated from the above that the present invention provides an optical control that is particularly straightforward and convenient in its construction and use. Furthermore, arrangements of the present invention allow the electrical components of the optical control to be directly mounted on a single, e.g. main, e.g. control panel, printed circuit board (unlike in conventional optical controls and encoders where all the components are located in enclosed housings which must be electrically connected, say by wiring or soldering, to the main printed circuit board). In addition, where it is desired to provide a number of optical controls on a printed circuit board, it is possible to mount all of the electronic components on the same printed circuit board, thus significantly simplifying the construction.

The present invention therefore extends to methods of constructing optical controls. Thus, from a further aspect, the present invention provides a method of constructing an optical control or controls, comprising mounting the light sources and light detectors of one or more optical controls on a printed circuit board, and attaching a housing and/or other mechanical components of the control or controls to the printed circuit board.

The method can also include appropriately mounting the other components of the optical control, such as reflectors, apertured covers, control members, light transmitting means, etc., to the housing and/or circuit board, as desired. The light detectors could, as discussed above be mounted with each control, or a set of common light detectors could be used. The remainder of the printed circuit board could be used to mount, say, other optical controls, or other electronics required by the electrical apparatus. As discussed above, where plural optical controls are mounted on a single printed circuit board, the housing of each control preferably extends to the same height above the circuit board.

The invention also extends to kits for constructing optical controls in accordance with the present invention.

Thus, from a further aspect, the present invention provides a kit for an optical control, comprising:

a housing;

a movable control member mounted or mountable in the housing; and

one or more reflectors for location in the housing.

The reflectors in the kit are preferably, as discussed above, capable, in use, of reflecting and concentrating light from one or more light sources onto one or more light detectors or into one or more light transmitting (or redirecting) means.

In the case where the kit is for an optical encoder, the kit may further include a code generating member of any suitable form. The kit may also include one or more apertured covers, as described above, for location over the light detectors, etc., of the control. The kit preferably includes all the non-electronic parts required for construction of the optical control.

If desired, the kit may further include the electronic components, such as light sources and light detectors, which may then be pre-installed on a printed circuit board before the housing is fitted over them. The kit could also include appropriate light transmitting means (such as optical fibres) where these are to be used.

As discussed above, the present invention facilitates the use of plural optical controls on a single circuit board. In such an arrangement, the output of each control (whether electronic or optical (e.g. where a single set of detectors receives the light output from plural optical controls)) is preferably received and processed in a common processing unit, e.g. microcontroller. In such an arrangement, particularly where the outputs of all of the controls and encoders are received by a common set of detectors, the system preferably polls each control in turn to receive (and read) its output. To achieve this, the microcontroller could, for example, activate the light source, or light sources, of each control in turn and log the response from the control (i.e. store or read the code generated by the control which indicates the state or position of the control). The microcontroller can then repeatedly cycle through the controls, activating the light source(s) of each control in turn so that the position or state of all the controls can be ascertained.

It will be appreciated from the above that the present invention can be used with any suitable form of optical code generating pattern that varies the light output detected by the detector or detectors based on the position or state of the control.

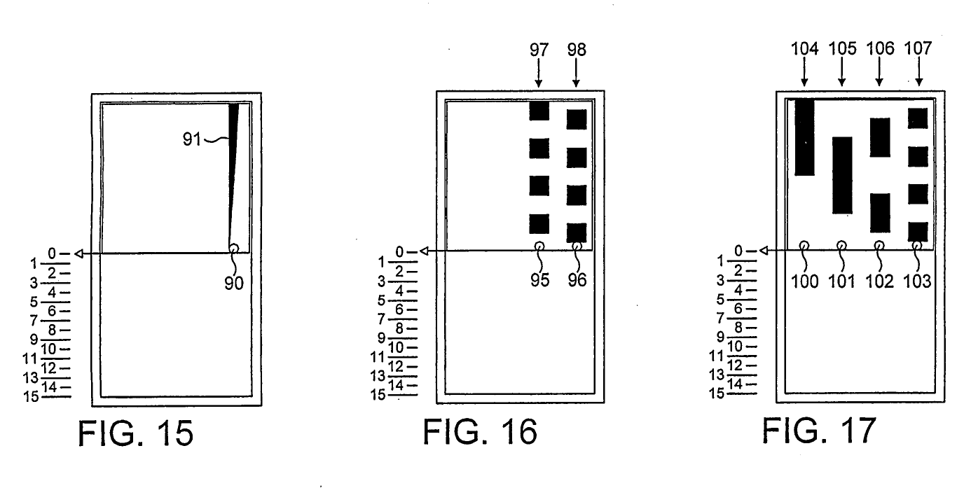

Thus it can, for example, be used with known analogue absolute encoding patterns. An example of such a pattern is shown in FIG. 15. In this arrangement, which is shown as a linear optical encoder, there is a single detector 90 over which a varying width opaque pattern 91 can be moved to indicate sixteen positions of the encoder. The linearly movable opaque pattern 90 acts as a varying width shutter that gradually and regularly varies the amount of light received by the detector 90 between maximum and minimum values at the ends of its extent of travel. A similar arrangement may be used for a rotary analogue absolute encoder, except in that case the opaque pattern 91 will follow a circular path. The pattern 91 could also instead vary in opacity (rather than width) along its length.

A second known form of encoding that can be used in the present invention is digital incremental encoding. A simple linear form of such encoding is shown schematically in FIG. 16. In this arrangement, there are two detectors 95, 96, and two optical encoding pattern tracks 97, 98 that are arranged to alternately and successively block the light output to the detectors 95, 96. The state of the control is determined by counting the successive alternate “on” and “off” states of the detectors as the control (encoding pattern) is moved.

It will be appreciated that in an “incremental” encoding arrangement such as that shown in FIG. 16, it is the relative changes in position of the control from a given “start” position that are indicated by the output of the control and that can be monitored. This should be contrasted with “absolute” encoding schemes where the “absolute” position or state of the control (as against its relative position) is indicated by the control's output (such that, e.g., each given position of the control has its own, unique output and each position can be determined from the control's output without reference to other positions of the control).

A third known form of encoding that can be used in the present invention is digital absolute encoding. This uses, as is known in the art, plural detectors and plural optical encoding tracks to selectively block given detectors to produce an effectively binary code output indicative of the position or state of the control. A preferred form of such digital absolute encoding is Gray coding. It is particularly preferred for each discrete control position to be indicated by a change in output state of one detector only. FIG. 17 shows schematically such a (linear) control that can be used to indicate 16 positions. There are four detectors 100, 101, 102 and 103, and four optical pattern tracks 104, 105, 106 and 107 that can be moved over the detectors.

Generally speaking each of the above encoding techniques can be used for linear or rotary controls and which technique to use will depend on the desired application, and accuracy and cost considerations, etc. For example, analogue absolute encoding allows more states to be indicated with fewer detectors, but can be susceptible to instability and resolution limitations due, e.g., to manufacturing tolerances and aging and temperature effects on the detector. Digital incremental encoding can avoid these problems due to the “on/off” nature of the detector output, but provides relative movement information only and requires continuous tracking and storage of the control's position.

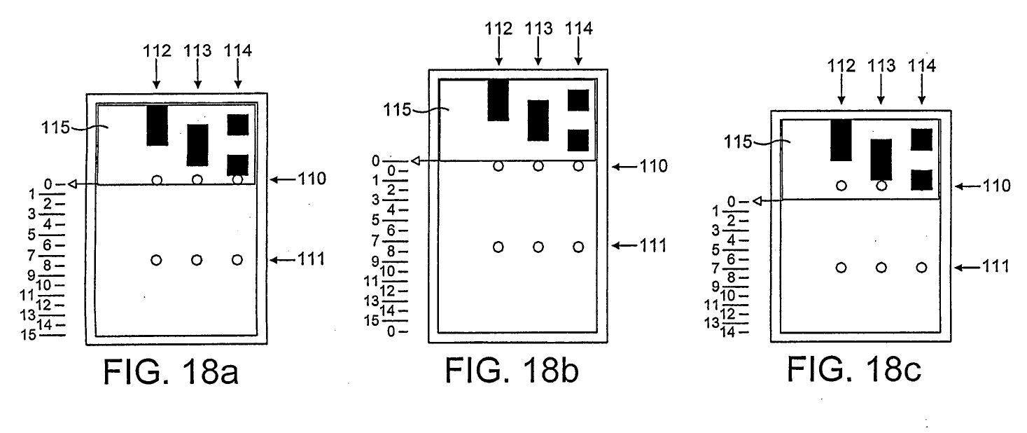

Digital absolute encoding can avoid these drawbacks, but is more costly in terms, e.g., of the number of detectors required (and hence overall control size) for any given number of total encoding positions. The Applicants have also recognised some further drawbacks even with digital absolute encoding. These drawbacks will now be discussed with reference to FIGS. 18, 19 and 20.

FIGS. 18, 19, and 20 show schematically a linear optical control that provides a maximum resolution of 16 positions. This control uses two rows 110, 111, each of three detectors, and a shutter 115 that carries three optical pattern tracks 112, 113 and 114 that can be moved linearly over the rows of detectors to indicate the position of the control.

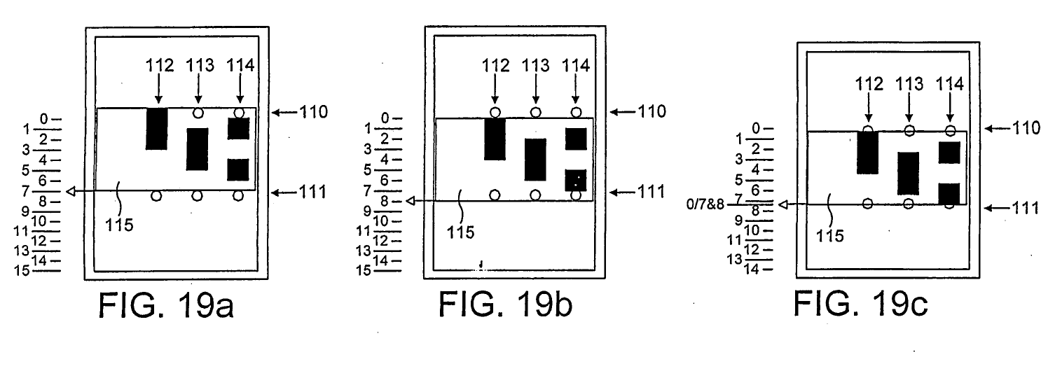

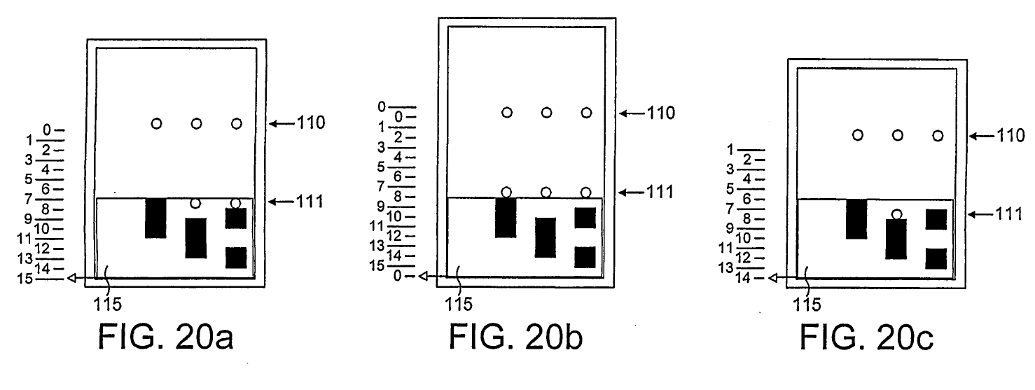

FIGS. 18a, 18b and 18c illustrate the control with the shutter (and hence control) in the topmost outer position (encoding in this arrangement “0”), FIGS. 19a, 19b and 19c illustrate the position of the control in a middle position where there is a detector row transition (encoding in this arrangement “7”), and FIGS. 20a, 20b and 20c illustrate the position of the control in the bottommost outer position (encoding in this arrangement “15”).

FIG. 18a shows the situation in the topmost outer position of the control where the control case dimensions, control member (shutter) dimensions and travel, etc., are correctly matched and accurate. No detector in the row 110 is blocked, thereby correctly giving a reading of “0”.

FIG. 18b shows the situation of FIG. 18a (i.e. the topmost position) but where there is an overtravel error in the control member's (and hence shutter's 115) position due to, e.g., the inner case of the control being too large (which could be caused by, e.g., manufacturing error). However, again, no detector in the row 110 is blocked and so the correct reading is obtained notwithstanding this error.

FIG. 18c shows the converse situation to FIG. 18b. In this case, there is an undertravel error (e.g. due to the inner case of the control being too small) and so the control cannot be moved to a position where all the detectors in row 110 are unblocked. This means that a reading of “0” can never be obtained for the topmost position (which could, as will be appreciated by those skilled in the art, affect the function of the control to a greater or lesser extent).

FIGS. 20a, 20b and 20c show the corresponding situation for the bottommost position of the control. FIG. 20a shows the correct situation in which the bottommost left detector in row 111 is blocked, thereby indicating position “15”. FIG. 20b shows the situation where there is an overtravel error. In this case no detector in the row 111 (or the row 110) is blocked. This gives a reading of “0”, which is a major decoding error. FIG. 20c shows the situation where there is an undertravel error. In this case both the left and right end detectors in row 111 are blocked, thereby giving an erroneous reading of “14” (and meaning that position “15” is “out of range” of the control).

FIGS. 19a, 19b, and 19c illustrate similar situations around the control position of the control where there is to be a row transition between the outputs of the detectors in rows 110 and 111 (i.e. where the row of detectors giving a reading of “0” (i.e. all detectors unblocked) should change). FIG. 19a shows the correct situation for the position “7”. One detector in row 110 is blocked and no detectors in row 111 are blocked. FIG. 19b shows the position where the control has been moved down one position to position “8” but due to errors, e.g., in the detector rows' spacing and/or in the optical pattern spacing, in fact no detectors in either row 110 or row 111 are blocked. This would give a reading of “0”, which clearly is incorrect.

FIG. 19c shows the situation similar to FIG. 19b but where the detector rows 110 and 111 have been moved closer together to try to avoid the possibility of a reading of “0” as in FIG. 19b arising. However, there is still the difficulty in this situation of ensuring within the restrictions of manufacturing tolerances that both detector row state transitions happen at the same time. Thus, there is still the risk that one detector row will change state before the other, thereby leading to a reading of “0” as above, or to a reading of position “7” and “8” simultaneously (i.e. with both detector rows 110 and 111 providing a non-zero output) (which is still an error, albeit potentially a less significant error than a reading of “0”).

It will be appreciated that the above problems that the Applicants have recognised can occur with digital absolute encoding may, for example, not be significantly detrimental in the context of a given optical control and/or may be avoidable or rendered negligible by sufficiently careful and/or accurate construction of the optical control. However, the Applicants believe that in some circumstances at least, it may be desirable to further ensure against and/or to try to avoid such problems arising.

Thus, in a particularly preferred embodiment of the present invention where absolute digital encoding is to be used, the number of positions to be indicated by the control is set to be less than the maximum number of positions that could be encoded given the available outputs of the control that can be detected. In other words, rather than using the minimum number of output (e.g. detector) positions and corresponding optical pattern encoding tracks required to encode the desired number of discrete positions (such as 3 adjacent detectors and 3 adjacent optical encoding pattern tracks to encode 8 positions), a greater number than the minimum number of different output readings (e.g. detector positions) and corresponding optical pattern encoding tracks required to encode the desired number of discrete positions is used.

This type of arrangement has the advantage that it provides some redundancy of different encoding arrangements over the number of positions it is desired to indicate, which can then be exploited to enhance the flexibility and reliability of the encoding arrangement. Indeed, such arrangements have been found, as will be explained further below, to help to reduce or avoid position-determining errors due to, for example, over or under travel of the optical control and/or errors in determining detector row transitions (where more than one row of detectors is used).

Most preferably one more encoding track (and hence output position) than the minimum number required is used. Thus, for example, where 8 discrete positions are to be encoded, rather than using three output reading positions (e.g. detectors) in a row and three adjacent encoding tracks, four output positions and four adjacent encoding tracks are preferably used.

It is believed that such arrangements may be new and advantageous in their own right. Thus, according to a yet further aspect of the present invention, there is provided an optical control that uses a digital absolute position encoding scheme, comprising:

a shutter member carrying one or more adjacent optical encoding tracks; wherein:

the control is arranged such that the number of discrete control positions indicated by the optical control is less than the maximum number of discrete positions that could be indicated by the number of encoding tracks provided on the shutter.

According to another aspect of the present invention, there is provided a method of constructing an optical control that uses a digital absolute position encoding scheme, comprising:

determining the number of discrete positions that it is desired for the control to be able to indicate; and

providing an optical shutter member carrying optical encoding tracks that could be used to encode more discrete positions of the control than the determined number of discrete positions.

A particular advantage of using more than the minimum number of output readings and corresponding optical encoding tracks is that allows all of the desired control positions to be represented by output states in which at least one of the outputs being read is in a different state to the remaining outputs of the control. This avoids, for example, a control position being indicated by all the outputs (e.g. detectors) being in the same state (i.e. all “on” or all “off”) (which may then correspond to the “background” of the optical control's optical shutter member and can therefore, as discussed above, relatively easily arise erroneously in certain situations).

Thus it is particularly preferred that all the discrete positions of the control that it is desired to indicate are indicated by output states in which at least one output of the control is in a state that is different to another output of the control (e.g. it is off when the other output is on or vice-versa). Thus, accordingly, it is preferred that there is no control position that is indicated by all the control outputs (e.g. detectors) being “on” (i.e. unblocked and receiving light) and/or vice-versa.

It is again believed that such arrangements may be advantageous in their own right. Thus, according to a yet further aspect of the present invention, there is provided an optical control that provides plural optical outputs that can be read to indicate the position of the control, wherein the control is arranged such that at least one optical output of the control is in a different state to another optical output of the control for each position of the control that it is desired to indicate.

According to another aspect of the present invention, there is provided an optical control that provides plural optical outputs that can be read to indicate the position of the control, wherein the control is arranged such that a control state in which all the optical outputs of the control are in the same state is not used to indicate a position of the control.

Even if there are some positions of the control that are to be indicated by all the outputs of the control being in the same state, it is strongly preferred that the (i.e. typically both) “end” positions of the control (i.e. the positions at the ends of travel of the control) are represented by coding states in which at least one output of the control is in one state (e.g. blocked) and some or all (and most preferably all or at least all apart from one) of the remaining outputs of the control are in a different (in the other) state (e.g. unblocked). This avoids the end positions of the control being indicated by all the outputs being in the same state (i.e. all “on” or all “off”).

It is again believed that such arrangements may be advantageous in their own right. Thus, according to a yet further aspect of the present invention, there is provided an optical control that provides plural optical outputs that can be read to indicate the position of the control, wherein the control is arranged such that at least one optical output of the control is in a different state to another optical output of the control at each end position of the control.

According to another aspect of the present invention, there is provided an optical control that provides plural optical outputs that can be read to indicate the position of the control, wherein the control is arranged such that a control state in which all the optical outputs of the control are in the same state is not used to indicate an end position of the control.

Most preferably in such arrangements it is the outer outputs, i.e. the outputs at the edges of the set of outputs of the control (e.g. leftmost and rightmost outputs in a linear encoder or innermost and outermost outputs in a rotary encoder) that are set to be the (one) output in the state opposite to the (majority of) the remaining outputs (with one “edge” output being in that state for one end of the travel of the control and the other “edge” output being in that state for the other end of the travel of the control).

In another particularly preferred embodiment of the present invention, the encoding patterns for the end positions of the optical control (i.e. at the ends of its travel) are extended such that they are provided over a range of movement of the optical control that is greater than the range of movement over which corresponding position patterns for other positions of the optical control (and in particular for positions at or towards the centre of the range of movement of the control) are provided.

As will be appreciated by those skilled in the art, each discrete, optically identifiable position of the control would normally be spaced equally (and by a predetermined amount) from the adjacent positions of the control (such that there is a regular step size between the discrete control positions). By allowing the encoding patterns for the end positions of the control to extend over a greater range of movement than the standard single position-change step-size for the other positions of the control, it is possible to provide a greater position range over which the optical control can be positioned at the ends of its travel whilst still indicating correctly the end travel position of the control. This helps to reduce or even avoid, e.g., errors due to overtravel or undertravel at the ends of travel of the control due to, e.g., manufacturing tolerances.

It is again believed that such an arrangement may be advantageous in its own right. Thus, according to a yet further aspect of the present invention, there is provided an optical control in which discrete output patterns of the control provide an indication of the control's position or state, wherein: the output patterns for indicating a or each end position of the control's range of travel extend for a greater range of movement of the control than an or each output pattern for indicating a non-end position of the control.

Preferably the greater encoding pattern range for the end positions of the control extends for at least two and preferably at least three position step sizes (based on the step size for position changes in the centre portion of the control's range of travel), although in practice any suitable size can be selected. The size selected will, for example, depend on the manufacturing errors that are expected and/or that it is desired to tolerate.

It will be appreciated that this arrangement is particularly applicable where the end positions of the control are indicated by one output of the control having a different state to the (or the majority of) the remaining outputs of the control, as then there is a distinct position-indicating state that can be provided over an extended range of movement.

As discussed above, another area in known digital absolute encoding schemes where position determination errors can arise is in the context of transitions from using the read-out of one output row to using the read-out of another output row as indicating the position of the control (in controls where plural rows of outputs are or can be read). As discussed above, there would ideally be a smooth transition in a single position step change between one output row becoming inactive and the next row becoming active. However, in practice that can be difficult to achieve.

Thus, in a particular preferred embodiment of the present invention where more than one row of outputs is or can be used to determine the overall output of the control, the determination of the position of the control is preferably based on the control outputs received or detected by two of the rows of outputs. This facilitates better identification of which output row is to be “active” at any given time, particularly in the region of row transitions. The output of more than two output rows could be considered, but using two rows only is preferred as in practice there will only ever tend to be a transition between two adjacent rows of outputs, and taking the outputs of two rows is sufficient for that situation. Thus, accordingly, it is preferred that the outputs of two adjacent output rows are used in the position determination.

Most preferably the output of one row of optical outputs is used to determine when the row of optical outputs to be taken as indicating the current position of the optical control should be changed. Preferably in such an arrangement, the output of a given row of optical outputs is taken to be indicative of the current position of the control until that output row enters a particular, preferably predetermined, output state or states, at which point the output of a different row of optical outputs is then taken to be indicative of the control's current position. In other words, the output row being interpreted to determine the control's position is changed, when the current output row enters a particular output state or states.

It is again believed that such arrangements may be new and advantageous in their own right. Thus, according to another aspect of the present invention, there is provided an optical control which provides an output that can be used to determine the position of the control in the form of two or more spaced apart rows of optical outputs, wherein the control is arranged such that the output of one of the two or more spaced apart rows of optical output can be used to determine that another row of optical output should be used to determine the position of the control.

According to another aspect of the present invention, there is provided an optical control which provides an output that can be used to determine the position of the control in the form of two or more spaced apart rows of an optical output, wherein the control is arranged such that the output of one of the two or more spaced apart rows of optical output can be used to determine that the row of optical output to be used to determine the position of the control should be changed.

According to another aspect of the present invention, there is provided a method of reading the output of an optical control that provides an output that can be used to determine the position of the control in the form of two or more spaced apart rows of optical outputs, comprising:

determining the position of the control from the output state of one of the rows of optical outputs until that row of optical outputs enters a particular state or states, and then determining the position of the control from a different row of optical outputs.

In these embodiments and aspects of the invention, as discussed above, preferably the output of one row of control outputs is taken as being indicative of the control's position, and/or the output row from which the control's position is interpreted is changed, only if the other output row being considered enters or is in a or more than one particular, preferably predetermined, state. The particular state or states could be selected as desired, but conveniently could comprise, e.g., all the outputs in that row being in the same state (e.g. blocked or unblocked) and/or just one output in that row being in a different state to the remaining outputs in that row. Most preferably the particular state or states are states in which at least one optical output in the row is in a different state to another optical output in the row, as that again helps to avoid erroneous row transitions.

It is preferred in these arrangements that the end states of the control (which in practice will tend to be and preferably are the particular states discussed above that determine which row's output is to be considered) extend, as discussed above, over a greater movement range than the other (middle) states of the control, as that helps to ensure that one output row will be in the particular state when the transition to the next output row is to occur and thereby further facilitates positive indication and identification of the output row transition.

It will be appreciated that the above preferred features of the encoding scheme can be applied to analogue absolute encoding schemes as well as digital absolute encoding schemes. Thus, for example, in an analogue encoding scheme, the “end states” of the control can be extended to allow for over and under travel, and, where appropriate, the outputs of two output rows (e.g. rows of detectors) can be used to determine the control's position.

Where an analogue absolute encoding scheme is being used, then it would be possible by providing additional outputs and using plural encoding tracks to divide the overall encoding range into plural smaller ranges, each of which can then be encoded in an analogue fashion but with greater value changes between successive analogue positions, if desired. Such an arrangement could be used to reduce the resolution required to interpret the analogue output between successive positions, albeit at the expense of requiring, e.g., more output detectors.

It is believed that such an arrangement may be new and advantageous in its own right. Thus, according to a further aspect of the present invention, there is provided an optical control that uses an analogue encoding scheme to provide an optical output indicative of its position, wherein the control comprises plural analogue encoding tracks.

In these embodiments and aspects of the invention, the plural analogue encoding tracks could be arranged side-by-side and/or underneath one another (relative to the direction of travel of the control), as desired. The control will preferably include plural detectors (or light transmitting means, etc.), i.e., provide plural outputs, that can be attenuated, etc., appropriately by the plural encoding tracks. Thus preferably the optical control provides plural outputs that can be read together to determine its position.

Thus, according to a further aspect of the present invention, there is provided an optical control that uses an analogue encoding scheme to provide an optical output indicative of its position, wherein the control provides plural optical outputs that can be read to determine the control's position.

Where analogue encoding is being used, and there are, for example, plural optical outputs, it is preferred that only one output at any one time will be changing its state, with the states of the other outputs remaining unchanged (and most preferably, either fully blocked or fully unblocked).

In a particularly preferred embodiment, particularly where the control has plural output rows (e.g. rows of detectors), the or each analogue encoding track preferably has encoding regions (e.g. opaque regions on a clear background or vice-versa) that provide a gradual variation in light output that reaches a peak (or minimum) at a central position of the track and that gradually decreases (or increases accordingly) towards each end of the track. In this way there is a graduated change in light output from high to low to high (or vice-versa) as the encoding track moves progressively over (or in front of) a given output. This helps to facilitate, e.g., output row transitions and identifiable output state changes.

Such an output sequence can be achieved as desired. For example, where the output track has a varying width opaque (or clear) region that passes over a detector (or other light receiving means), it could have a shape that tapers towards either end and has a wider centre portion, such as an appropriate triangular, quadrilateral (e.g. trapezoidal (i.e. a quadrilateral with no parallel sides)) or other shape. Suitable shapes would include, e.g., diamonds or parallelograms.

It is again believed that such arrangements may be advantageous in their own right. Thus, according to a yet further aspect of the present invention, there is provided an optical control comprising an encoding track that is arranged to provide an analogue output signal indicative of the position of the control, wherein the encoding track is arranged such that as control is moved unidirectionally along its range of travel, the analogue output signal changes progressively from a minimum value to a maximum value and then returns progressively to the minimum value.

It will be appreciated that in this arrangement, the minimum output value may be maximum or minimum light output, with the maximum value being the opposite, accordingly. The control could also include plural encoding tracks, and where it does, preferably each encoding track is arranged such that as the control is moved unidirectionally along its range of travel, the analogue output signal changes gradually or incrementally from a minimum value to a maximum value and then returns gradually or incrementally to the minimum value.

Where analogue encoding is being used, it is also preferred to provide one or more reference outputs (e.g. detectors) that can be used for comparison purposes to, e.g., attempt to compensate the readings from the position indicating outputs for environmental, aging, etc., effects. Such reference outputs could comprise, e.g., an always fully lit detector whose output changes can be tracked to provide an indication of changes that are, e.g., likely to also be occurring in the other detectors.

It will be appreciated that in all of the above arrangements, the “outputs” of the control could be provided directly to suitable detectors provided in the control, or could be provided, as discussed above, to suitable light transmitting (and/or redirecting) means that will then convey the control's output(s) to remote detectors. Thus references to output or outputs, detectors, rows of outputs and detectors, etc., should be construed accordingly.

It will be appreciated that in the optical encoding arrangements of the present invention, the optical encoding patterns may comprise discrete opaque areas on a transparent (or translucent) background (as may be more usual in the art). However, they may equally comprise transparent or translucent areas on an opaque background, and the present invention should therefore be understood to extend to such arrangements equally.

The present invention will now be described, by way of example only, and with reference to the accompanying drawings in which:

FIG. 1 illustrates a rotary optical encoder in accordance with a preferred embodiment of the present invention;

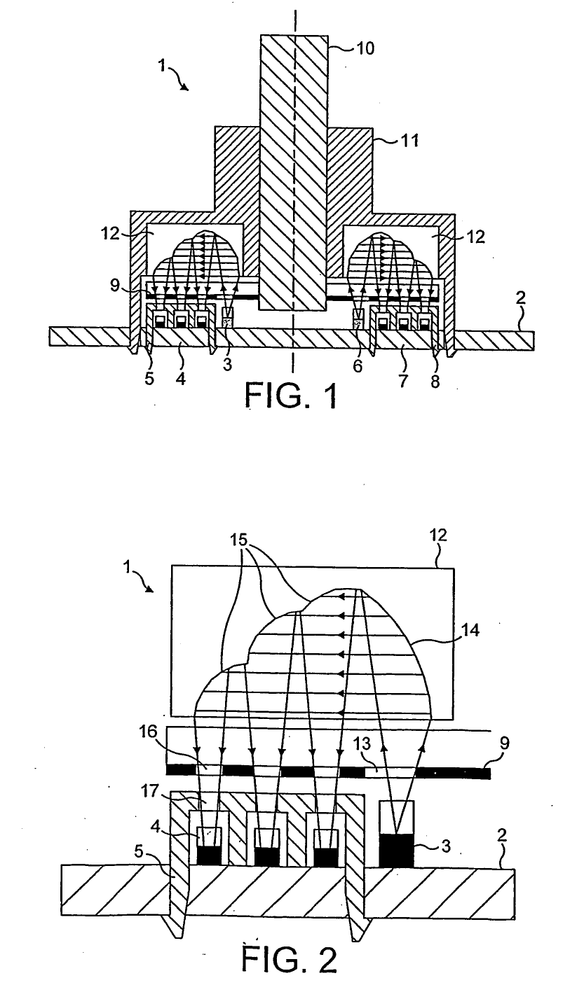

FIG. 2 is a more detailed view of the device shown in FIG. 1;

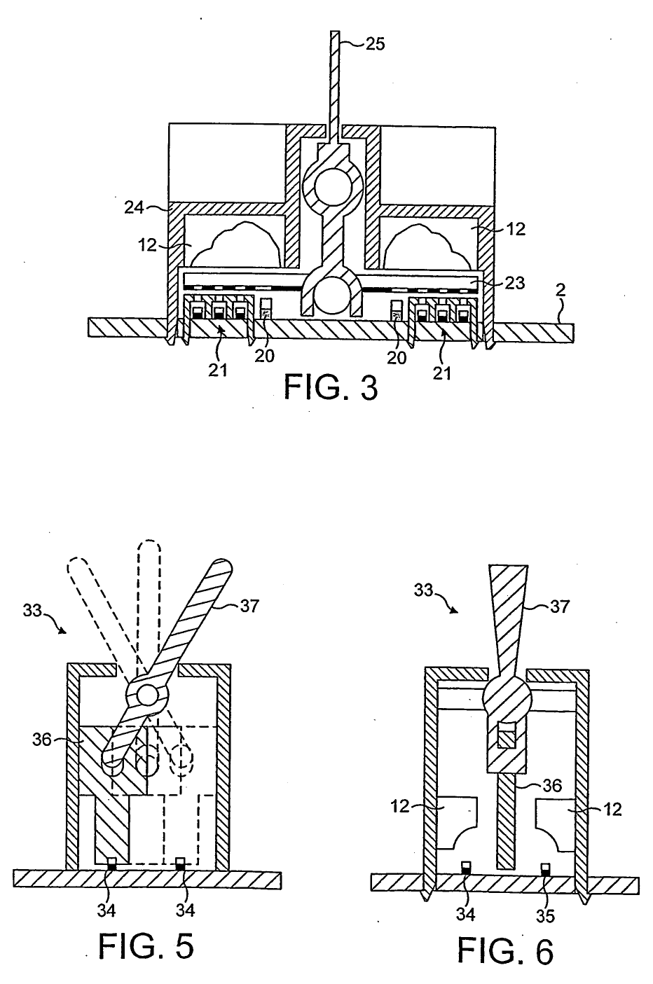

FIG. 3 illustrates a linear optical encoder in accordance with another preferred embodiment of the present invention;

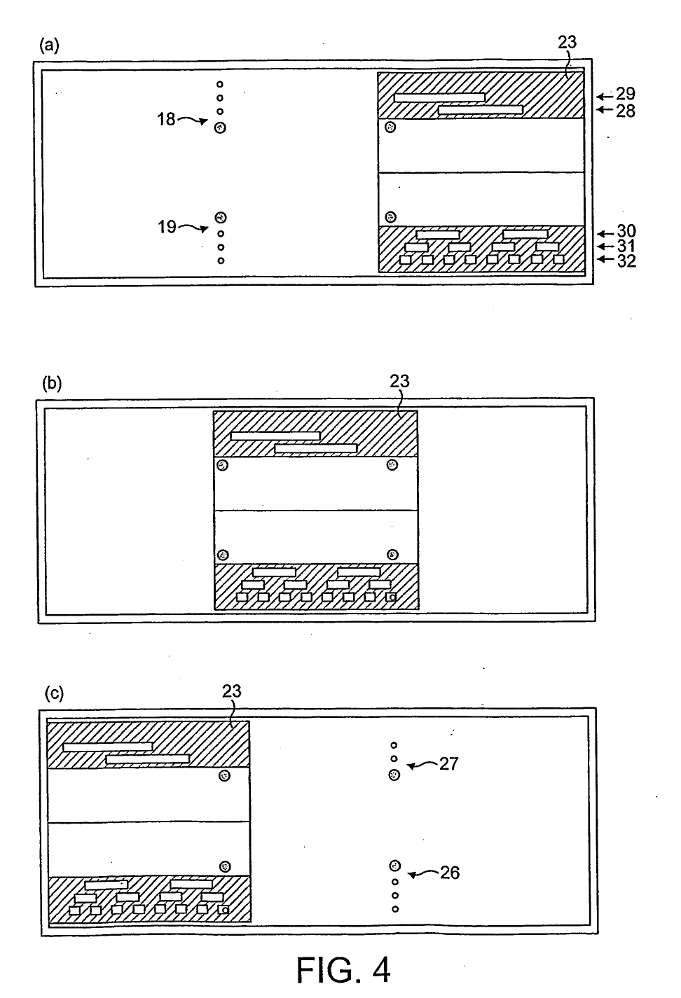

FIG. 4 illustrates the relative movement of the code generating member with respect to the light sources and light detectors of the linear encoder shown in FIG. 3;

FIG. 5 illustrates a three-way switch in accordance with a further embodiment of the present invention;

FIG. 6 illustrates a side view of the three-way switch shown in FIG. 5;

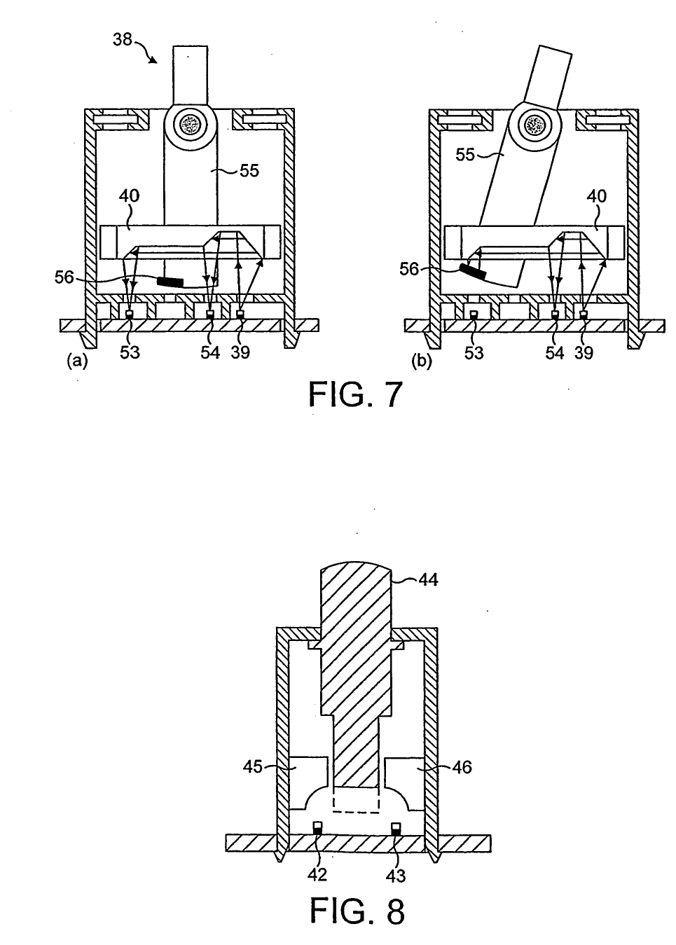

FIG. 7 illustrates another embodiment of a three-way switch in accordance with the present invention;

FIG. 8 illustrates a push button switch in accordance with a further embodiment of the present invention;

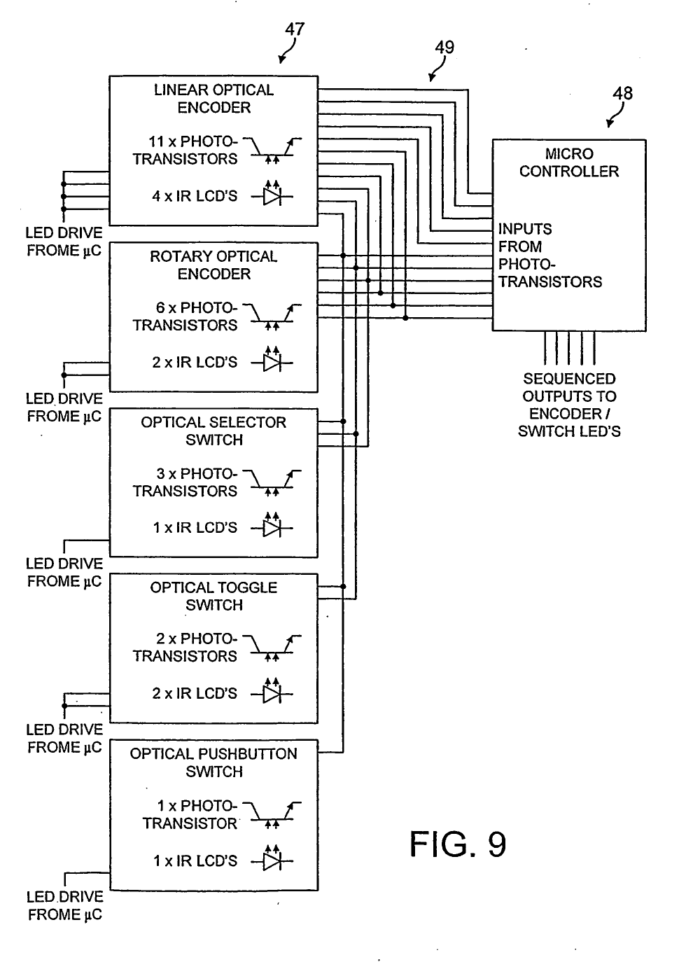

FIG. 9 shows an exemplary electric circuit configuration for coupling plural optical controls in accordance with an embodiment of the present invention;

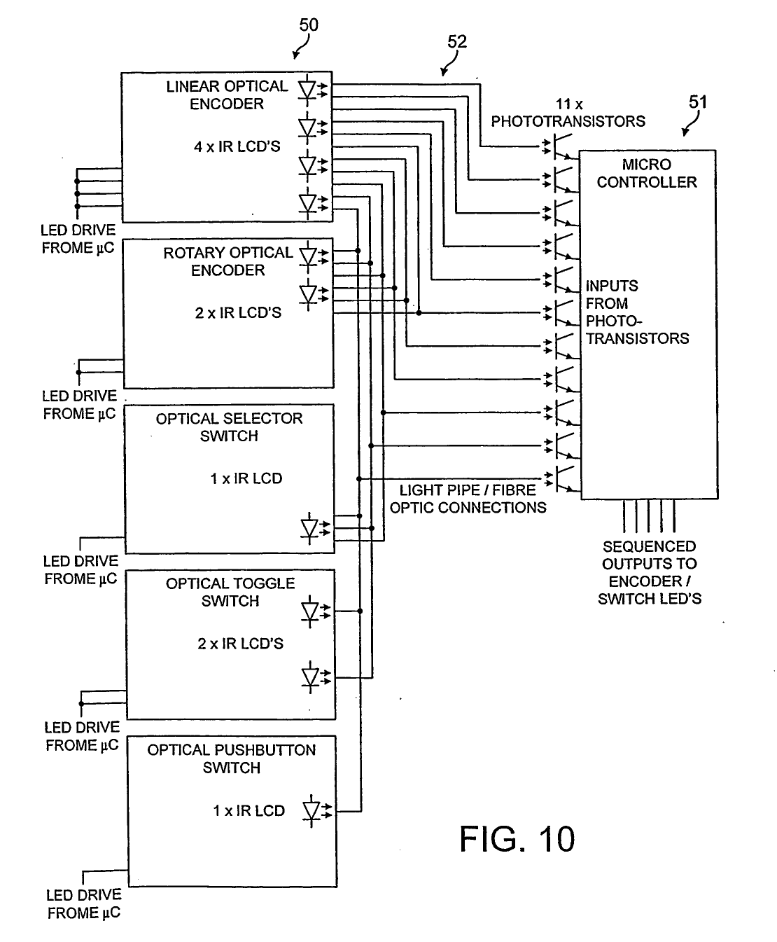

FIG. 10 shows an exemplary optical circuit configuration for coupling plural optical controls in accordance with an embodiment of the present invention;

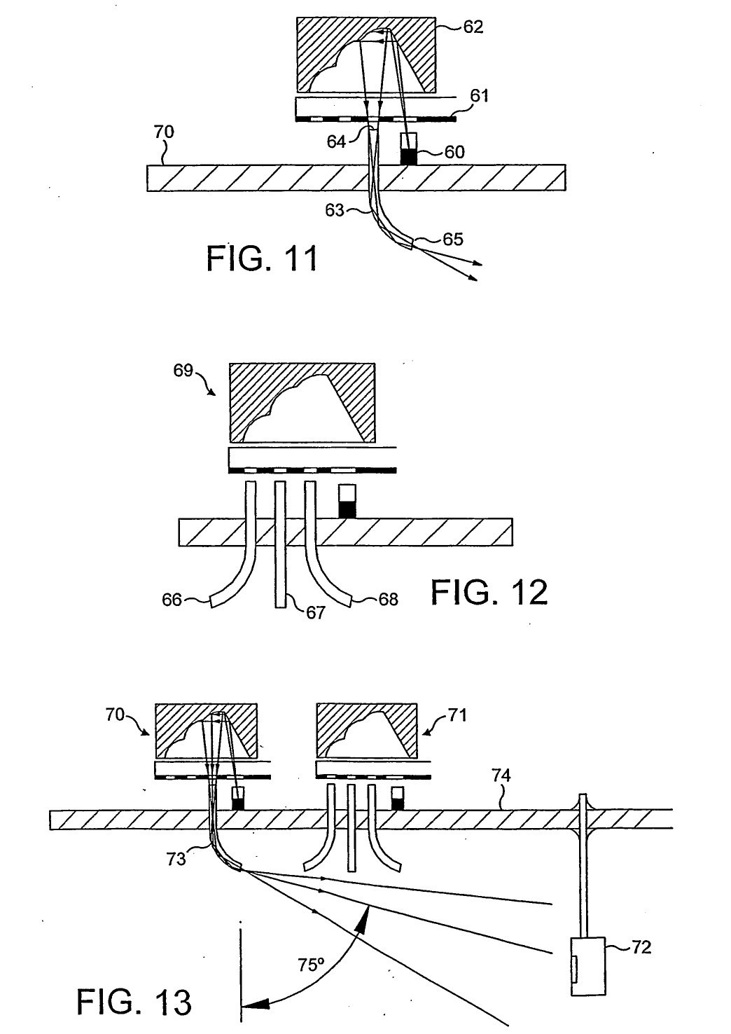

FIGS. 11 to 14 show another exemplary optical circuit configuration for coupling plural optical controls in accordance with an embodiment of the present invention;

FIG. 15 shows schematically an analogue absolute optical encoding arrangement;

FIG. 16 shows schematically a digital incremental optical encoding arrangement;

FIG. 17 shows schematically a digital absolute optical encoding arrangement;

FIGS. 18, 19 and 20 show schematically a digital absolute optical encoding arrangement in a number of different situations;

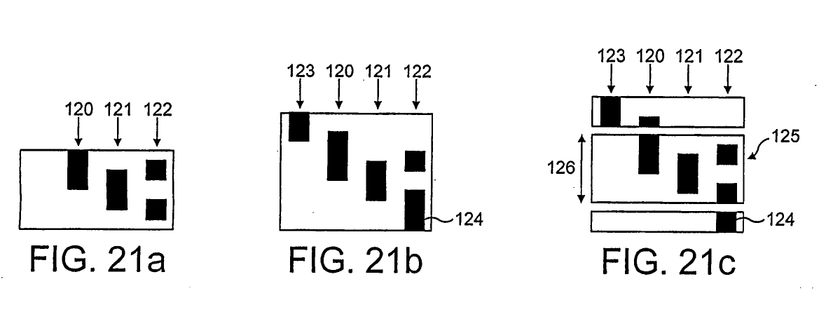

FIGS. 21 to 24 illustrate a modified digital absolute encoding scheme in accordance with a preferred embodiment of the present invention; and

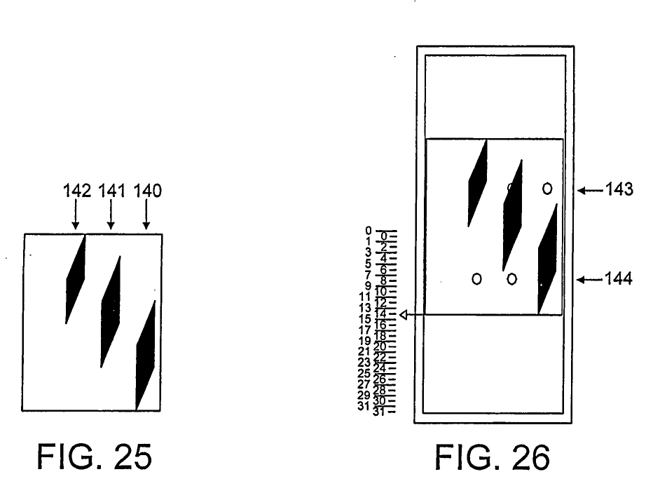

FIGS. 25 to 27 illustrate a modified analogue absolute encoding scheme in accordance with an embodiment of the present invention.

FIG. 1 shows an optical control in the form of a rotary optical encoder 1. The encoder could have end stops or be continuous. The encoder 1 comprises a shaft 10 mounted for rotation within a housing 11. The rotatable shaft 10 may be connected to a turn knob structure (not shown) which can be grasped by a user to rotate the shaft 10. The housing 11 is attached to a printed circuit board (PCB) 2 by a snap-fit connection.

A (Gray) code generating disk 9 is located within the housing 11 and is attached to one end of the rotatable shaft 10 such that rotation of the shaft 10 causes rotation of the code generating disk 9.

The optical encoder 1 includes two light sources 3, 6, in the form of infra-red light emitting diodes (LEDs). Adjacent to each light source 3, 6 a series of three light detectors 4, 7 are arranged in a line extending radially from the axis of rotation of the code generating disk 9. The light detectors 4, 7 comprise, for example, phototransistors. The light sources 3, 6 are located generally in line with their respective series of three light detectors, and in this case are located radially between the light detectors and the axis of rotation of the code generating disc 9.

The control further includes an apertured covers 5, 8 arranged over the light detecting members 4, 7. The covers are formed from moulded plastic and attached to the printed circuit board (PCB) 2 by a snap-fit connection. Each cover is formed with three apertures, one for each light detector, that allow light to pass through the cover 5 for detection.

As can be seen, the light sources 3, 6 and the light detectors 4, 7 are mounted directly to the printed circuit board and lie on the same side of the code generating disk 9 and face in the same direction.

On the opposite side of the code generating disk 9 is provided a reflector 12 which redirects the light from the light sources 3, 6 to the detectors 4, 7.

The operation of the reflector 12 is illustrated in FIG. 2. FIG. 2 shows the arrangement for the light source 3 and light detectors 4 of FIG. 1, but as will be appreciated by those skilled in the art, the corresponding arrangement and processes take place with the light source 6 and detectors 7 of FIG. 1. The reflector 12 comprises a first parabolic reflective surface 14 which reflects the incident light from the light source 3 into a number of parabolic secondary reflective surfaces 15, each of which reflects and concentrates light through the apertured cover 5 towards a particular light detector 4. The first reflective surface 14 is parabolic to help collimate the light emitted from the light source 3 towards the secondary reflective surfaces 15. The secondary reflective surfaces 15 are parabolic to help focus (and thereby concentrate) the incident light onto a particular light detector.

In use, the light from the light source 3 passes through a transparent portion 13 of the code generating disk 9 and is appropriately reflected by the reflector 12 to provide three light beams, one for each light detector 4. These light beams return to the detectors 4 through the code generating disk 9.

As is known in the art, the disk 9 includes opaque and transparent regions 16 that will selectively block the light path to the detectors 4 (and 7). In this way the position of the disk 9 controls output of the detectors 4, 7, such that the light detectors' output is indicative of the disk's position (and hence of the position of the rotary control). Typically the pattern of apertures in the disk 9 will be such that the optical output provides a Gray code mapping of the disk's position, as is known in the art. The Gray code can, for example, be provided to and interpreted by a microprocessor or microcontroller, provided to and interpreted by a programmable logic device to output a signal recognisable by an analogue circuit (such as a stepped voltage or with another device as a change in resistance), etc., as is known in the art.

The arrangement shown in FIGS. 1 and 2 can encode 64 positions. The number of positions can be varied by using more or less light detectors. The switch could have end stops (e.g. to limit its rotation to 270°) and if being used as a selector switch could be constructed with intermediate stops to correspond to the Gray code positions.

FIG. 3 shows a cross-section of an optical linear slider control. The slider control includes similar components to the above described rotary optical control. The slider control comprises a slider 25 mounted in and extending from a housing 24. The housing 24 is attached to a printed circuit board 2 by means of a snap-fit connection. The slider 25 is linearly translatable relative to the housing 24. A code generating member 23 is attached to the slider 25 such that linear movement of the slider 25 causes corresponding movement of the code generating member 23 within the housing 24.

As can be seen in FIG. 3, the slider control is generally symmetrical when viewed in cross-section. Each side of the control is provided with a light source 20 and three light detectors 21. The light source 20 comprises an infra-red light emitting diode LED and the light detectors 21 comprise phototransistors. The light source 20 and the three light detectors 21 are arranged linearly. For a longer control plural sets of linearly spaced light sources and light detectors may be provided along the length of the control.

The code generating member 23 that is moved by the control and selectively blocks the light paths to the detectors comprises a generally rectangular element formed from a photographic material that is formed with transparent regions and opaque regions.

FIG. 4 shows an example of a linear control having four light sources and corresponding light detector positions (although only eleven light detectors are used) 18, 19, 26, 27. The code generating member 23 is moved linearly over these positions and includes a number of linear tracks of opaque and transparent regions 28, 29, 30, 31, 32 which, as can be seen, selectively block or transmit light to a given photodetector depending on the linear position of the code generating member 23. FIG. 4a shows the code generating member 23 at one end of its travel, FIG. 4b at its central position, and FIG. 4c at the other end of its travel. As can be seen from FIG. 4, each step of the code generating member 23 provides its own unique light detector “on” pattern. This allows the optical output from the light detectors to be used to determine the position of the code generating member 23 and thereby of the linear control. A longer control (and with more positions) could be provided using additional rows of light sources and photodetectors.

The dimensions of the linear control can be selected as desired. For example, for a 45 mm travel slider, there could be one row of five and one row of six photodetectors light detectors (as shown) giving 64 positions each of step size 0.7 mm.

FIGS. 5 and 6 illustrate an optical three-position lever switch that operates in accordance with the present invention. FIG. 5 is a front view and FIG. 6 a side view of the switch. The switch 33 includes a user operable control member 37 which can be moved to move a member 36 between three positions (left, centre and right). The switch includes two light sources 34 and two light detectors 35. The light sources 34 are arranged so that the member 36 in its “left” position blocks the light output from one light source 34 from reaching one light detector 35 and when in its “right” position blocks the light output from the other light source 34 from reaching the other light detector 35. When the member 36 is in its “centre” position it does not block light from either light source 34 from reaching its respective light detector 35. Thus a unique code can be generated for the three positions of the switch lever.

FIG. 7 shows an alternative embodiment of a three-position lever switch that operates in accordance with the present invention. In this switch 38 there is only one light source 39 whose output is directed and concentrated by a reflector 40 towards two light detectors 53, 54. As can be seen from FIG. 7, the switch 38 includes a user operable control member 55 that can be moved between three positions (left, centre and right). The control member 55 is transparent to the radiation emitted by the light source 39 except in an opaque region 56. The arrangement is such that in the “centre” position of the switch, the opaque region 56 does not block light transmission to either detector 53, 54 (i.e. such that both detectors receive light from the light source 39). This is shown in FIG. 7(a). However, in the “right” position of the user operable member 55, the opaque region 56 blocks the light path to the detector 53 and vice-versa (as shown in FIG. 7(b)). Thus again a unique code is generated for each of the three positions of the switch lever.

The switches shown in FIGS. 5, 6 and 7 have a toggle action, but a slide action could also be used. For a two-position lever switch, only one light source and light detector would be required.

FIG. 8 illustrates a push button switch in accordance with the present invention. The switch includes a push button 44, a light source 42, reflectors 45, 46 and a light detector 43. The push button 44 can be selectively operated by a user to block the light path from the light source 42 to the light detector 43, but is resiliently biassed towards its outward position. This type of switch is an example of a “latching” or “momentary” switch as the push button 44 is biassed towards a particular position (either the on or off position) by means such as a spring so that after the push button 44 has been pressed it returns to its original position (usually the off position).

As has been discussed above, the present invention in particular facilitates the use of plural optical controls on a single circuit board or in a single electronic element. In such an arrangement it may be desirable that while each optical control may produce its own output (whether electrical or optical) the outputs of the various optical controls are processed and handled by a common, single processing unit, such as a microcontroller. FIGS. 9 to 14 illustrate appropriate arrangements to achieve this.

FIG. 9 shows five optical controls 47 which provide via their respective light detectors electrical outputs indicative of their state via wires 49 to a common microcontroller 48. FIG. 9 shows five different optical devices, each of which possesses a different number of light sources and light detectors, including an optical linear encoder, an optical rotary encoder, an optical selector switch, an optical toggle switch, and an optical push-button switch. However, as will be appreciated by those skilled in the art, this selection of optical controls is exemplary only and, furthermore, the connections shown between the components are illustrated schematically. These electrical connections may comprise wires, circuits on printed circuit boards, and so on, as is known in the art.

As can be seen, each optical device 47 includes an electrical input for each light source (infra-red LED) present within the control. Each optical device also includes an electrical output from each light detector (phototransistor) present within the control. The electrical outputs from the light detectors with the same weight (from LSB to MSB) are connected in parallel to the microcontroller 48. The microcontroller also provides the electrical input required by each light source. In order to read the state of each optical control, the microcontroller interrogates each control in turn by activating the light sources within that control. An electrical response is then received from that controller which indicates the current state of that control. The microcontroller 48 then switches its attention to the next optical control and so on.

FIG. 10 shows an alternative form of interconnection between a number of optical controls 50 and a microcontroller 51. Unlike the arrangement shown in FIG. 9, the components shown in FIG. 10 are not interconnected by electrical connections but are instead connected optically via optical fibres 52. In this arrangement, the controls 50 are not individually provided with light detectors which provide a electrical signal to the microcontroller when exposed to light from a light source. Instead, the light from the light sources within each optical control is transmitted as light via optical fibres 52 to a single, common, set of light detectors 53 arranged at the microcontroller 51. In this way an optical connection is provided between the optical controls and microcontroller 51. This arrangement can save, for example, on the number of light detectors required.

FIG. 10 shows an arrangement in which the light output of the optical controls are conveyed by means of optical fibres to a single, common, set of light detectors. It would also be possible for the light output of the plural optical controls to propagate through free air to a single, common, set of light detectors in such an arrangement, and that may be advantageous, for example, where significant numbers of optical fibres from many optical controls might need to be routed in the system. FIGS. 11 to 14 illustrate an arrangement in which the light output from plural optical controls propagates through free air to a common set of detectors.

FIG. 11 shows schematically the layout of part of an optical control in this embodiment. The optical control still includes a light source 60, code generating disk 61 and reflector 62, as in the preceding embodiments. However, the optical control instead of being provided with its own light detector or an optical fibre that extends to a remote detector is provided with a short length or stub 63 of optical fibre or other suitably transmissive material (such as clear plastic) that is arranged to receive the light output from the optical control at one end 64 and to emit that light output from its other end 65 so as to redirect the light output from the optical control in an appropriate direction (in practice to redirect the light output towards an appropriate detector).

The short length or stub of light transmissive material 63 can take any suitable form but in general will have a relatively small diameter compared to its length in order for it to be able to capture light at its input end and conduct it for emission at its other end. Suitable dimensions for the light transmissive stub would be, for example, a diameter of 0.6 mm and a length of around 10 mm, and it should be curved along its length appropriately so as to redirect the light.

The stub of light transmissive material 63 is inserted through an appropriate small hole drilled in the substrate or printed circuit board 70 that the optical control is mounted on and extends above the substrate (circuit board) to a height that matches, for example, the height of the detector cover apertures in the previous embodiments discussed above. The stub of light transmissive material could also be covered by an aperture, if desired, but this is not necessary as the stub of light transmissive material will tend only to capture light that is incident on its end face 64 and so will be less susceptible to stray light interference, etc., in any event.

FIG. 12 shows schematically an arrangement of light transmissive stubs 66, 67, 68 for an optical encoder 69 that has three optical outputs. It can be seen from FIG. 12 that the different stubs of light transmissive material 66, 67, 63 are arranged to each direct the light that they output in a different direction. This facilitates the outputs of each stub of light transmissive material not interfering with the outputs of the other stubs of light transmissive material.

FIG. 13 shows schematically the arrangement of two optical controls 70, 71 in accordance with FIGS. 11 and 12 and a corresponding remote detector 72. It can be seen that after leaving the end of the stub 73 of light transmissive material, the light output of the optical control 70 propagates through free air to the detector 72.

It can be seen from FIG. 13 that the stub 73 of light transmissive material is not arranged to turn the direction of travel of the light through 90°, but rather is bent an angle of around 75°. This is so that the emitted light will propagate below, and not be blocked by, neighbouring stubs of light transmissive material (of the same or neighbouring optical controls). The detector 72 is accordingly mounted a sufficient distance below the main substrate 74 that mounts the various controls and detectors, such that it is in line of sight of the light emitted by the light transmissive stub 73.

As shown in FIG. 13, the light emerging from the stub of light transmissive material 73 is in the form of a relatively evenly distributed but divergent beam. The divergent nature of the beam will lower the light energy captured by the detector 72, but on the other hand will allow for larger tolerances in directing the light output towards the detector. However, to take account of the divergent nature of the light as it propagates through the air, it is preferred that different light detectors are located at a sufficient distance from each other so as to avoid as far as possible receiving light intended for any of the other detectors. This can be assisted by, for example, locating each detector to a distinctly different location on the substrate, for example at different corners of the substrate.

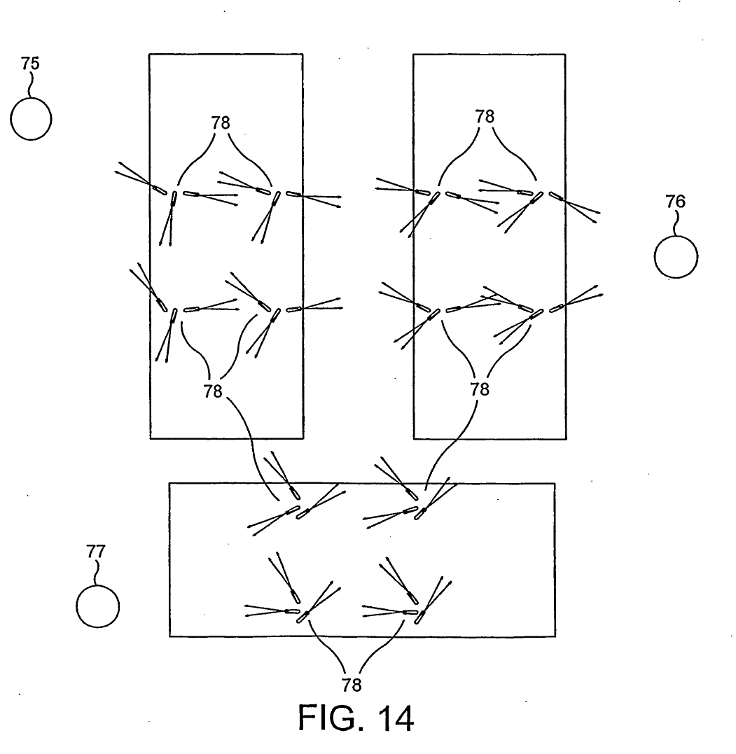

Such an arrangement is shown schematically in FIG. 14, in which the location of three different detectors 75, 76, 77 are shown relative to plural optical controls 78. It can be seen that each optical control has three light outputs, each being directed to one of the three spaced detectors.

Furthermore, the equivalent or corresponding outputs of each control 78 (e.g. the same bit position or binary weighting output) are all directed to the same detector. In particular, the most significant bits of each control are all be directed to the detector 75, the least significant bits are all directed to the detector 76, and the middle bits are all directed to the detector 77. This facilitates reading of the output of each optical control by the common set of detectors.

It can be seen from FIG. 14 that the distance from each individual optical control to the corresponding detectors will differ. This should not cause any difficulty in situations where digital encoding is being used (i.e. such that the detector simply needs to determine whether the corresponding output is “on” or “off”). However, where an analogue system is in use, such differing propagation distances through free space between optical controls and the corresponding detectors may need to be taken into account when processing the outputs of a given optical control.

In the arrangement shown in FIG. 14, the states of the individual optical controls are determined by the system polling each individual optical control in turn, i.e. by sequentially switching the light sources of each individual optical control on in turn and detecting the corresponding output. In this way, it can be ensured that the light detectors receive light from one optical control only at any one time, such that the control states of the individual optical controls can be unambiguously determined.

It will be appreciated that the exact layout of the optical controls, detectors and stubs of light transmissive material in arrangements such as that shown in FIG. 14 can be varied as desired (as can the form of the particular optical controls being used), so long as there is a sufficiently free line of sight between the emitting end of a given stub of light transmissive material and its associated light detector.

FIGS. 21 to 24 illustrate a modified digital absolute encoding scheme for a linear optical control in accordance with another preferred embodiment of the present invention. FIG. 21a shows a regular absolute Gray code optical encoding pattern with three adjacent optical encoding tracks 120, 121 and 122 of alternate opaque and transparent regions that can indicate eight unique positions when read by a corresponding row of three detectors.

FIG. 21b shows a preferred embodiment of a modified version of the Gray code encoding scheme shown in FIG. 21a. As can be seen in FIG. 21b, there has firstly been added an additional encoding track 123 (which will therefore necessitate an additional detector). In addition, the encoding track 122 has been modified such that its lowermost portion is an extended opaque region 124 (in contrast to the arrangement shown in FIG. 21a in which the track 122 has a transparent region at its lowermost portion).

FIG. 21c shows schematically the differences between the modified Gray code scheme shown in FIG. 21b and the regular Gray code scheme shown in FIG. 21a. As can be seen from the centre portion 125 of FIG. 21c, the modified Gray code scheme of the present embodiment retains the seven top positions of the regular eight position Gray code scheme shown in FIG. 21. However, the opaque region of the encoding track 120 is extended by one position towards the top of the encoding member, and an additional encoding track 123 having an opaque region at top of the encoding member that extends over a number of linear position steps in the direction of travel 126 of the encoding pattern (in the present case for three position encoding steps) has been added. The extension of the opaque region of encoding track 120 and the extended additional encoding track 123 help to block both row transition errors and under and overtravel errors at the ends of travel of the Gray code member.

It can also be seen from FIG. 21c that the rightmost encoding track 122 has, as discussed above, an extended opaque region 124 (that extends in this case for two position steps in the direction of travel 126 of the encoding pattern beyond the “bottom” of the Gray code scheme shown in FIG. 21a). This extended opaque region helps to block both row transition errors and under and over travel errors at the top end of travel of the Gray code member.

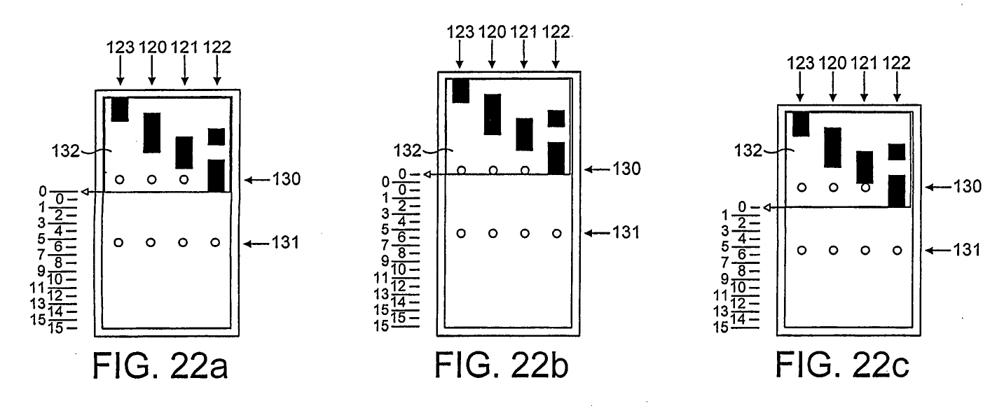

FIGS. 22, 23 and 24 show schematically the operation of the modified Gray coding scheme shown in FIG. 21b in the same situations as shown in FIGS. 18, 19 and 20, respectively, above, and in particular illustrate how the modified absolute Gray coding scheme of FIG. 21b can help to avoid and reduce both row transition and over and under travel errors.

Again, the arrangement shown is for a linear optical control having two rows of detectors, 130 and 131, and a shutter member 132 that carries the encoding pattern of FIG. 21b. It will be appreciated that in this embodiment the shutter member 132 has a length of twelve “step” positions (as compared to, e.g., eight positions for the control shown in FIG. 18) and that therefore the control will be physically bigger. However as discussed above and below, this increased size of the control is compensated for by the increased accuracy and reliability of the control.

FIG. 22a corresponds to FIG. 18a and illustrates the correct position at the top of the range of travel for the optical control. The position “0” is indicated by the rightmost detector in row 130 being blocked, but the remaining detectors being unblocked. FIG. 22b corresponds to FIG. 18b and illustrates the situation where there is an over travel error of one position step size. However, again, the output reading is still the rightmost detector in row 130 being blocked and the remaining detectors being unblocked, i.e. correctly indicating the position “0”. FIG. 22c corresponds to the situation shown in FIG. 18c, where there is undertravel of one position step size at the top position of the optical shutter member 132. However, again, with the modified Gray code scheme of FIG. 21b, the detector state is still the rightmost detector in row 130 being blocked and the remaining detectors being unblocked, thereby still correctly indicating position “0”.

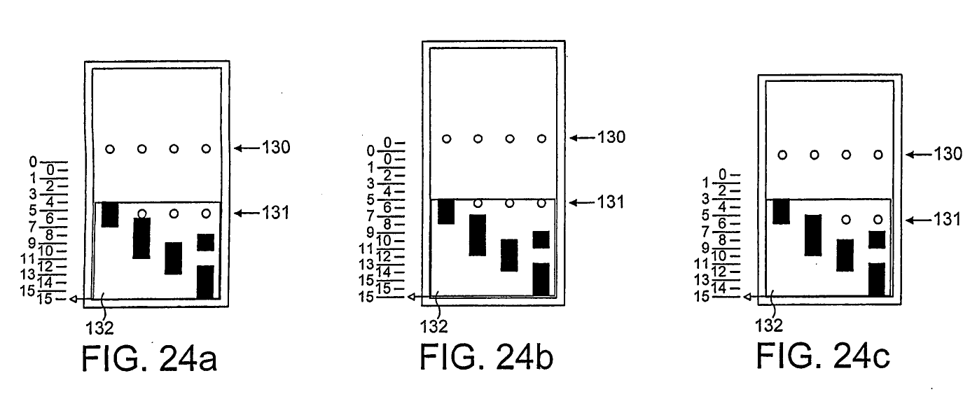

FIGS. 24a, 24b and 24c show the corresponding arrangements at the bottom end of the travel of the shutter member 132 and thus correspond to the situation shown in FIG. 20. Thus, FIG. 24a shows correct positioning of the shutter member 132 at the end of its travel, with a reading of the detectors of row 131 of the leftmost detector being blocked and the remaining detectors being unblocked indicating position “15”. FIG. 24b shows the situation where there is overtravel by one position step size (analogously to FIG. 20b). In that case, the state of the detectors in row 131 is still the leftmost detector blocked and the remaining detectors unblocked, thereby correctly indicating the position “15”.

FIG. 24c shows the situation where there is undertravel of one position step size (corresponding to FIG. 20c). In that case, the state of the detectors in row 131 is the two leftmost detectors being blocked and the remaining detectors being unblocked. However, the encoding scheme is set up such that that combination of detector states also indicates position “15” (thereby giving a correct position indication). It will be noted in this regard that for the next step upwards (i.e. position “14”), the detector state in row 131 will be (reading from left to right) for the first, third and fourth detectors to be unblocked and the second detector to be blocked, i.e. different to the two states that are indicative of position “15”.

It can be seen from these Figures that the modified Gray code arrangement shown in FIG. 21b can take account of and compensate for over and undertravel errors at the ends of the travel of the Gray code carrying shutter member 132, albeit with the need for an additional Gray code track and detector in each detector row.

The extended range at the relevant regions at the end of travel of the shutter member 132 that the Gray code tracks extend over (e.g. in terms of position step size) can be selected as desired and need not be exactly as shown in FIGS. 21, 22, 23 and 24. For example, for a very high resolution and/or low manufacturing standards, the extended regions of the tracks at the end of the travel of the shutter may need to be further extended. On the other hand, shorter extended regions may be acceptable if the resolution is very low and/or high manufacturing standards apply and/or only a limited “dead” outer range can be tolerated.

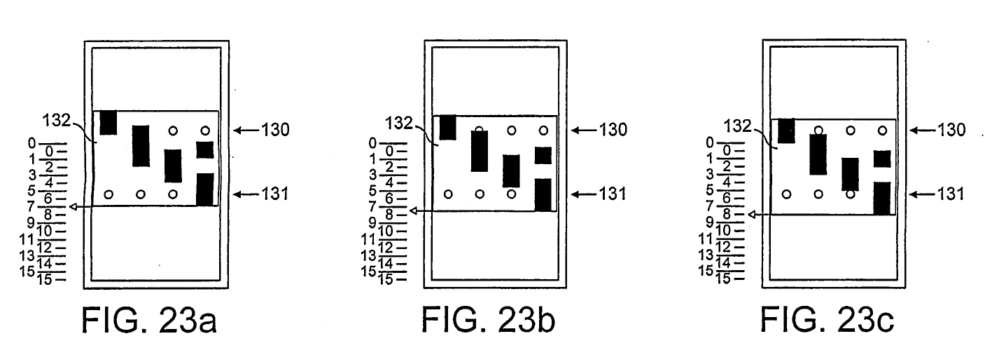

FIGS. 23a, 23b show schematically the operation of the linear control using the modified Gray coding scheme of FIG. 21b around the position of the detector row transition (i.e. the change between reading the output of the detector row 130 to reading the output of the detector row 131 (i.e. around the middle position of the control member shutter 132)). This is similar to the situation shown in FIGS. 19a, 19b and 19c above.

FIG. 23a shows the position of the shutter when the control is in position “7”. In FIG. 23a the reading of position “7” is taken from row 130. The transition to position “8” which is read from detector row 131 is shown in FIGS. 23b and 23c.

It can be seen that fully in line with the Gray code principle, in this range of movement of the shutter 132, only one detector changes its state at any one time in the currently “active” detector row. However, it will be also noticed that the code and accordingly detectors in the far upper left corner of encoding track 123 and the far lower right corner of encoding track 122 do not strictly speaking comply with this principle, as they also change states simultaneously with other detectors. However, those encoding tracks are only acting upon the other, “non-active” row of detectors, and this feature is exploited to provide a modified decoding procedure that helps to reduce and avoid ambiguous detector row (and therefore position state) transitions.

The procedure adopted is as follows: the “active” detector row (i.e. the detector row from which the main position reading is to be taken) is determined to be the other row of detectors to the row of detectors that has only one of its endmost detectors blocked or no detector blocked at all. In other words, once the currently “active” detector row enters a state in which only a particular one of its endmost detectors is blocked or none of its detectors is blocked, then the other detector row is taken to become the “active” row of detectors and to now indicate the valid position code.

Thus in the examples shown in FIGS. 23a, 23b and 23c, the position of the optical control is determined from the state of detector row 130 until as shown in FIG. 23b, detector row 130 reaches the stage where only its leftmost detector (under the track 123) is blocked or no detector is blocked at all, upon which event, the system then treats detector row 131 as being the “active” detector row that then holds the valid position code. The position is then determined by reading the state of detector row 131 (as shown in FIG. 23c) and then adding to that read state the appropriate number of positions (which in the present example is “8” positions, since the detector row 131 is 2⁽⁴⁻¹⁾ (i.e. 8) positions underneath the detector row 130). (As will be appreciated by those skilled in the art, the decoding process needs to take account of the relative positions of the detector rows and which detector row is currently “active” to determine the true position of the control.)

In practice in the embodiments shown in FIGS. 23a, 23b and 23c, the decoding electronics will add eight positions to the position number indicated by the lower detector row 131 to determine the position of the control.

FIG. 25 shows schematically a modified analogue absolute Gray encoding method that corresponds to the modified digital absolute Gray encoding method shown in FIG. 21b. As the encoding scheme shown in FIG. 25 is an analogue scheme, the “hard” fully opened block code state transitions used in the digital scheme are changed into gradually changing state transitions in order for the decoding electronics to interpolate between positions. One advantage of this arrangement over the digital scheme is that this therefore allows more positions to be indicated with fewer detectors and encoding tracks, but there is accordingly a need to ensure that reliable transitions between analogue encoding positions can be determined. For this reason it is preferred with analogue encoding methods to also provide some form of output reference, such as fully lit detectors, to allow the, e.g., decoding electronics to compensate for changes in, e.g., detector output due to, e.g., environmental conditions or aging, etc.

The modified absolute Gray coding encoding scheme shown in FIG. 25 has three encoding tracks 140, 141 and 142, which are arranged such that at any one time there is a single state transition with one detector only. The use of three encoding tracks divides the overall movement range into plural equal sub-ranges. As each sub-range can effectively move over the full range of movement of the control, but only has to encode a sub-range of the overall number in positions that the control can have, each sub-range can effectively space the positions that it has to encode further “apart”, as compared to if only a single or fewer encoding tracks were used, thereby allowing there to be larger “step” sizes (i.e. output changes) between adjacent analogue positions. In effect, there is a division of the positions to be encoded into discrete sets of positions (the sub-ranges), similar to in a digital encoding scheme, but each set of positions is still encoded and indicated in an analogue fashion. Thus the encoding range could, e.g. be divided into several, sub-encoding ranges using a digital absolute (Gray) coding pattern, but with analogue encoding then being used to indicate a range of positions at each discrete “digital” position.

As can be seen from FIG. 25, each analogue encoding track has a tapering, triangular shape at the top and bottom of the opaque region of each code track. This allows for the gradual changes between states that are required for analogue encoding. There could be further opaque regions arranged underneath the illustrated opaque region of a or each encoding track if desired.

FIG. 26 shows schematically a linear optical control similar to that shown in FIGS. 22 to 24 using the analogue encoding scheme of FIG. 25. Again, there are two rows of detectors, 143 and 144. It can be seen that with this analogue encoding scheme, a resolution of 32 positions can be provided, even though there is one detector less per detector row than for the digital absolute encoding scheme shown in FIGS. 22 to 24. As discussed above, this is an advantage of using an analogue absolute encoding scheme.

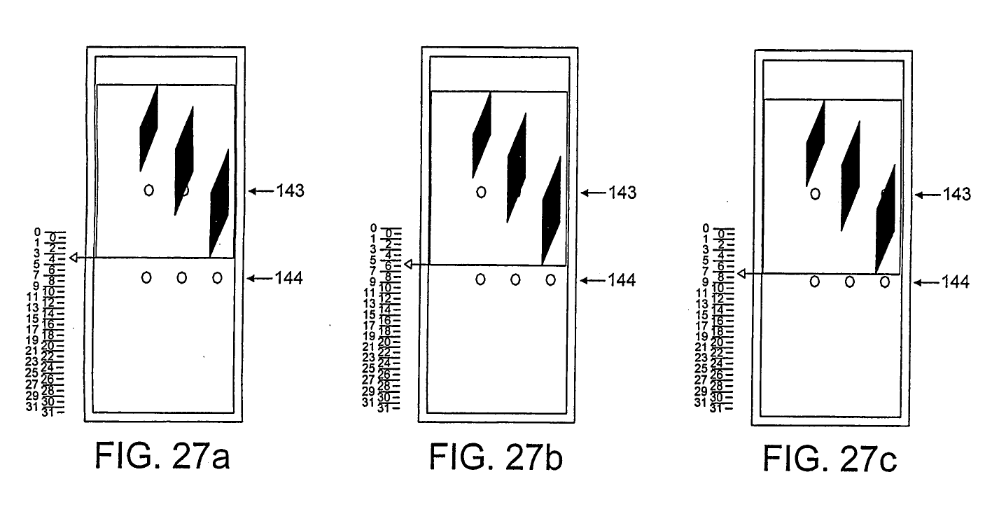

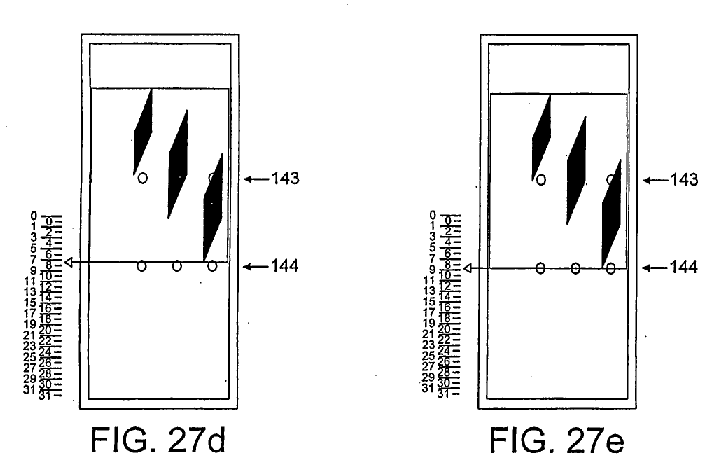

FIGS. 27a, 27b, 27c, 27d and 27e show schematically the movement of the analogue absolute encoding linear optical control of FIG. 26 between the positions “4” to “8”. It can be seen that during this movement, only one of the detector's output varies, with the other detectors remaining in unchanged states (i.e. either fully blocked or fully open). In the positions of the detector shown in FIG. 27a to 27e, it can be seen that there is a transition of the active detector from being the centre detector in the detector row 143 to being the rightmost detector in that row.

It will be appreciated that in all of the above arrangements, the “outputs” of the control could be provided directly to suitable detectors provided in the control, or could be provided, as discussed above, to suitable light transmitting (and/or redirecting) means that will then convey the control's output(s) to remote detectors.

It will also be appreciated that although in the optical encoding arrangements of the present invention described above, the optical encoding patterns have been shown as comprising discrete opaque areas on a transparent (or translucent) background, they may equally comprise transparent or translucent areas on an opaque background.

Whilst the present invention has been described with reference to preferred embodiments, it will be apparent to those skilled in the art that various changes can be made in form and detail without departing from scope of the invention.

In particular, the invention has been described, in part, in relation to optical encoders of a type know as “absolute” encoders which allow the absolute position of a mechanical element to be identified. The invention is however equally applicable to relative or “incremental” optical encoders in which the tracks of a code generating disk are divided into a regular series of transparent and opaque regions such that the movement of a control member from one position to another produces a series of pulses which can be counted to provide an indication of how far the control member has moved.

The present invention can be used for optical controls generally, such as linear controls, e.g. encoders, of various lengths, rotary controls, e.g. controllers with or without stops, selector switches, lever switches and push button switches, etc., and whether providing a “digital” or an “analogue” output.

1-68. (canceled)

69. An optical control, comprising:
one or more light sources; and
a plurality of light detectors or light transmitting means, wherein light from one light source is concentrated towards two or more of the light detectors or light transmitting means.

70. The optical control of claim 69, further comprising one or more reflectors arranged to reflect light from the light source or sources to redirect that light and concentrate that light towards one or more locations.

71. The optical control of claim 69, wherein the control comprises light transmitting means and wherein the light transmitting means can transmit the optical output of the control to a light detector or detectors that is or are spaced apart from the optical control.

72. The optical control of claim 69, wherein the control provides an optical output indicative of the state or position of the control, wherein the control comprises light transmitting means and wherein the optical output can be transmitted by the light transmitting means to another remote component for subsequent processing.

73. The optical control of claim 69, wherein the control comprises light transmitting means comprising optical fibres.

74. The optical control of claim 69, wherein the control comprises light transmitting means and wherein the light transmitting means act to redirect the light from the optical control or controls such that it will propagate in free air towards a remote component or light detector or detectors.

75. The optical control of claim 74, wherein the light transmitting means comprise short lengths of light transmissive material that can accept light from the optical control at one end and emit it at their other end and are shaped so as to be able to redirect the light towards a remote component or detector or detectors.

76. The optical control of claim 74, wherein the light transmitting means are arranged so as to be able to conduct the optical output of the control under a substrate upon which the control is to be mounted and then direct it towards a remote component or detector or detectors.

77. The optical control of claim 74, wherein the control has plural optical outputs, and further comprises a number of light transmitting means corresponding to its number of optical outputs, each light transmitting means being arranged to redirect the light from a different output to propagate in free air in a direction that is different to the propagation directions of the remaining light transmitting means.

78. The optical control of claim 69, comprising a reflector or reflectors that concentrate the light from the light source or sources towards two or more of the light detectors or light transmitting means and that have a substantially parabolic shape.

79. The optical control of claim 69, comprising a reflector or reflectors arranged to reflect light from a single light source towards plural different locations.

80. The optical control of claim 69, comprising first and second reflective surfaces arranged such that the first reflective surface diverts light from a light source toward the second reflective surface which then directs and concentrates the light towards one or more locations.

81. The optical control of claim 69, comprising a reflector or reflectors arranged to redirect the light such that it generally returns towards the light source.

82. The optical control of claim 69, comprising one or more light directing means arranged to redirect and concentrate the light from the light source or sources such that it is concentrated in a direction back towards the light source or sources but laterally spaced therefrom.

83. The optical control of claim 81, wherein the light sources and light detectors or light transmitting means are arranged on the same surface.

84. The optical control of claim 69, further comprising a cover element having apertures in it arranged in the path of a concentrated light beam or beams.

85. The optical control of claim 69, further comprising a cover element formed with one or more apertures;
wherein the cover element is arranged such that light from a light source passes through an aperture in the cover element.

86. The optical control of claim 84, wherein the cover element is arranged over the light detectors or light transmitting means with its apertures positioned such that light from a light source must pass through an aperture in the cover element to reach the light detectors or light transmitting means.

87. The optical control of claim 69, further comprising a housing that can carry and cover one or more of the components of the control.

88. The optical control of claim 87, wherein the housing is arranged to cover the optical control and to extend a uniform height above a substrate on which the control and housing is to be mounted.

89. The optical control of claim 69, wherein the optical control uses an absolute digital encoding scheme to provide an output indicative of its position, and wherein the number of positions to be indicated by the control is set to be less than the maximum number of positions that could be encoded given the available outputs of the control that can be detected.

90. The optical control as claimed in claim 69, wherein the optical control uses a digital absolute position encoding scheme, and further comprises:
a shutter member carrying one or more adjacent optical encoding tracks; wherein:
the control is arranged such that the number of discrete control positions indicated by the optical control is less than the maximum number of discrete positions that could be indicated by the number of encoding tracks provided on the shutter.

91. The optical control of claim 89, wherein the control comprises one more encoding track than the minimum number of encoding tracks required to indicate the desired number of control positions.

92. The optical control of claim 69, wherein the control uses an absolute encoding scheme to provide an output indicative of its current position, and wherein the end positions of the control are represented by coding states in which at least one output of the control is in one state and some or all of the remaining outputs of the control are in a different state.

93. The optical control as claimed in claim 69, wherein the optical control provides plural optical outputs that can be read to indicate the position of the control and wherein the control is arranged such that at least one optical output of the control is in a different state to other optical outputs of the control at each end position of the control.

94. The optical control as claimed in claim 69, wherein the optical control provides plural optical outputs that can be read to indicate the position of the control and wherein the control is arranged such that a control state in which all the optical outputs of the control are in the same state is not used to indicate an end position of the control.

95. The optical control of claim 92, wherein the control is arranged such that an outer output of the control is in a state opposite to the remaining outputs of the control at the end positions of the control.

96. The optical control of claim 69, wherein the optical control provides plural optical outputs that can be read to indicate the position of the control and wherein all the positions of the control that it is desired to indicate are indicated by output states in which at least two outputs of the control are in different states to each other.

97. The optical control of claim 69, wherein the optical control provides plural optical outputs that can be read to indicate the position of the control and wherein there is no control position that is indicated by all the control outputs being in the same state.

98. The optical control of claim 69, wherein the optical control provides plural optical outputs that can be read to indicate the position of the control and wherein the control is arranged such that at least one optical output of the control is in a different state to another optical output of the control for each position of the control that it is desired to indicate.

99. The optical control of claim 69, wherein the optical control provides plural optical outputs that can be read to indicate the position of the control and wherein the control is arranged such that a control state in which all the optical outputs of the control are in the same state is not used to indicate a position of the control.

100. The optical control of claim 69, wherein the encoding patterns for the end positions of the optical control are extended such that they are provided over a range of movement of the optical control that is greater than the range of movement over which encoding patterns for other positions of the optical control are provided.

101. The optical control of claim 69, wherein discrete output patterns of the control provide an indication of the control's position or state and wherein the output patterns for indicating a or each end position of the control's range of travel extend for a greater range of movement of the control than an or each output pattern for indicating a non-end position of the control.

102. The optical control of claim 69, wherein the control provides at least two spaced-apart rows of optical outputs that can be read to indicate the position of the control, and wherein the control is arranged such that the output of one of the two or more spaced apart rows of optical outputs can be used to determine that another row of optical outputs should be used to determine the position of the control.

103. The optical control of claim 69, wherein the control provides at least two spaced-apart rows of optical outputs that can be read to indicate the position of the control, and wherein the control is arranged such that the output of one of the two or more spaced apart rows of optical outputs can be used to determine that the row of optical outputs to be used to determine the position of the control should change.

104. The optical control of claim 102, wherein the output of the one row of optical outputs that indicates that another row of optical outputs should be used to determine the position of the control or that indicates that the row of optical outputs to be used to determine the position of the control should be changed comprises the one row of optical outputs being in a predetermined state.

105. The optical control of claim 69, wherein the optical control uses an analogue encoding scheme to provide an output indicative of its position, and wherein a or each analogue encoding track has an encoding region arranged such that as the control is moved unidirectionally along its range of travel, the light output for that encoding track progressively decreases to a minimum and then progressively increases again, or vice-versa.

106. The optical control of claim 69, wherein the optical control uses an analogue encoding scheme to provide an optical output indicative of its position, and wherein the control comprises plural analogue encoding tracks.

107. The optical control of claim 69, wherein the optical control uses an analogue encoding scheme to provide an optical output indicative of its position, and wherein the control provides plural spaced-apart optical outputs that can be read to determine the control's position.

108. An optical control system comprising a plurality of optical controls one or more of said optical controls being in accordance with claim 69, wherein the optical controls each provide an optical output indicative of the state of the control; the system further comprising light transmitting means to transmit the optical outputs of the controls to a processing unit capable of reading the optical data generated by the controls.

109. The optical control system of claim 108, further comprising a common detector or set of detectors that is shared by plural optical controls.

110. An optical control system, comprising: a plurality of optical controls mounted on a substrate one or more of said optical controls being in accordance with claim 69, each optical control comprising one or more light redirecting means for directing its optical output to travel through free space to a remote detector or detectors that is or are common to the plurality of optical controls.

111. The optical control system of claim 110, wherein the equivalent or corresponding outputs of each optical control are transmitted to the same detector.

112. The optical control system of claim 110, wherein the detectors are mounted so as to be outside of and surrounding the optical controls that they service.

113. The optical control system of claim 110, further comprising means for polling each control in turn to read its output.

114. A control panel comprising a control panel printed circuit board and one or more optical controls one or more of said optical controls being in accordance with claim 69, the optical controls including light sources and light detectors, and light sources and light detectors of the controls being mounted directly on the control panel printed circuit board.

115. A method of constructing an optical control or controls, comprising mounting the light sources and light detectors of one or more optical controls on a printed circuit board one or more of said optical controls being in accordance with claim 69, and attaching a housing and/or other mechanical components of the control or controls to the printed circuit board.

116. A method of constructing an optical control in accordance with claim 69 and that uses a digital absolute position encoding scheme, comprising:
determining the number of discrete positions that it is desired for the control to be able to indicate; and
providing an optical shutter member carrying optical encoding tracks that could be used to encode more discrete positions of the control than the determined number of discrete positions.

117. A method of reading the output of an optical control in accordance with claim 69, wherein said optical control provides at least two spaced-apart rows of optical outputs that can be used to determine the position of the control, comprising:
determining the position of the control from the output state of one of the rows of optical outputs until that row of optical outputs enters a particular state or states, and then determining the position of the control from a different row of optical outputs.

118. A kit for an optical control in accordance with claim 69, comprising:
a housing;
a movable control member mounted or mountable in the housing; and
one or more reflectors for location in the housing.

119. A kit of parts for constructing an optical control in accordance with claim 69.
